(19) United States
(12) Patent Application Publication
(10) Pub. No.: US 2025/0285029 A1
(43) Pub. Date: Sep. 11, 2025

(54) Assisted Behavioral Tuning of Agents

(71) Applicant: PARALOG INC., Montréal (CA)

(72) Inventor: Carle Côté, Montréal (CA)

(73) Assignee: PARALOG INC., Montréal (CA)

(21) Appl. No.: 19/213,701

(22) Filed: May 20, 2025

Related U.S. Application Data
(63) Continuation of application No. PCT/CA2025/050228, filed on Feb. 21, 2025.
(60) Provisional application No. 63/557,299, filed on Feb. 23, 2024.

(51) Int. Cl. G06N 20/00; G06N 3/006

(52) U.S. Cl. CPC G06N 20/00; G06N 3/006

(57) ABSTRACT

System, method, devices and non-transitory computer-readable medium for calibrating an autonomous agent. A teachable behavior model is calibrated by deploying the autonomous agent in a controlled environment with teaching fixtures. Teachable parameters are altered to reduce the difference between an observed behavior and a target behavior. The autonomous agent is deployed into an uncontrolled environment with interacting element. An observed interaction performance is evaluated against a target interaction performance to identify an improvement objective. The autonomous agent may be an autonomous robot, a virtual actor, a non-playing character, or a decision agent.

### PRIORITY STATEMENT UNDER 35 U.S.C §.119 (E) & 37 C.F.R. §.1.78

This non-provisional patent application is a continuation application from the PCT patent application entitled “ASSISTED BEHAVIORAL TUNING OF AGENTS”, application number PCT/CA2025/050228, filed on Feb. 21, 2025, in the name of PARALOG INC., which claims priority based upon the prior U.S. provisional patent application entitled “ASSISTED BEHAVIORAL TUNING OF AGENTS”, application No. 63/557,299, filed on Feb. 23, 2024, in the name of PARALOG INC., both being incorporated herein by reference in their entirety.

### TECHNICAL FIELD

The present invention relates to autonomous agents, and, more particularly, to the calibration of autonomous agents.

### BACKGROUND

Autonomous agents, such as autonomous robots, animated characters, and Non-Player Characters (NPCs) in video games serve many roles. In the physical world, autonomous agents may perform specific tasks such as navigating an area for vacuuming or lawn mowing, delivering food or packages across a distance, or disinfecting surfaces. Some autonomous robots are designed to look like pets and respond to various visual, tactile, and audio stimuli. In a virtual environment, autonomous virtual agents may interact with elements from their virtual environment and one another, contributing to conveying a richer and more persuasive experience to a viewer or a participant of an interactive experience. In video games, NPCs may also contribute to advancing a plot, providing challenges, enriching the game's world, or enhancing the player's experience. The creation and configuration of these agents may involve a complex interplay of design, programming, rules, and storytelling.

At the heart of an autonomous agent lies a decision system—a framework that defines the behaviors of the agent, guiding how they may react to various stimuli or changes in their state or environment. Transitioning an agent from one state to another, such as from navigating to performing a task, or being idle to being active, requires careful consideration of the conditions that trigger these changes. This process becomes particularly intricate when attempting to simulate a wide range of behaviors, making the association of desired behaviors with specific state changes a challenging task.

The skills required to adjust and fine-tune autonomous agents' behavior are both broad and specialized, ideally encompassing areas such as artificial intelligence programming, psychology, and in some cases even narrative design. Programmers may focus on algorithms that can handle complex decision-making processes, while designers may be interested in ergonomics and how different behaviors impact the user's experience. A multidisciplinary approach generally needed for developing autonomous agents that behave in ways that are effective. Finding skilled people is challenging and involving multiple people in the process adds considerable friction given that a significant amount of trial and error may be required to achieve the desired behavior.

The complexity of tuning or calibrating autonomous agents impacts costs, development time, and even the scope of product development. Programming and nuanced behaviors, and iterating based on feedback are all time-consuming activities that can significantly extend development timelines. Furthermore, the ambition to create deeply interactive and reactive autonomous agents can lead to increased costs, from hiring specialized personnel to acquiring more advanced development tools.

The challenges associated with the development of autonomous agents have continuously increased over the years, as users keep expecting increasingly complex behaviors. The present disclosure at least partly addresses some of these challenges.

### SUMMARY

This summary is provided to introduce a selection of concepts in a simplified form that are further described below in the Detailed Description of Preferred Embodiments. This Summary is not intended to identify key features or essential features of the claimed subject matter, nor is it intended to be used as an aid in determining the scope of the claimed subject matter.

In a first aspect, the technique described herein relates to a method, system, device, and non-transitory computer-readable medium for calibrating an autonomous agent.

In accordance with the first aspect, a system for calibrating an autonomous agent is provided. The system includes the autonomous agent having a teachable behavior model assigned thereto, a controlled environment, and a calibration module. The teachable behavior model may include an active state from a plurality of defined states and one or more teachable parameter for transitioning the active state within the plurality of defined states. The controlled environment may include one or more teaching fixture and may be configured for deploying the autonomous agent thereinto. The calibration module may include one or more calibration processor configured to alter the one or more teachable parameter to reduce a difference between an observed behavior and a target behavior, thereby calibrating the teachable behavior model of the autonomous agent into a calibrated behavior model.

In embodiments, the system may also include an uncontrolled environment and an evaluation module. The uncontrolled environment may include interacting elements and may be configured for deploying the autonomous agent thereinto. The evaluation module may include one or more evaluation processor configured to identify an improvement objective when the autonomous agent is deployed in the uncontrolled environment. The calibration module may include a calibration communication module configured to receive the improvement objective, and the target behavior include the improvement objective.

In embodiments, the one or more evaluation processor may further be configured to identify an interacting element configuration from the interacting elements contributing to an observed interaction performance when the autonomous agent is deployed in the uncontrolled environment, and the one or more teaching fixture may be configured to mimic the interacting element configuration when the autonomous agent is deployed in the controlled environment.

In embodiments, the evaluation module may include a user-interface module with one or more user-interface widget and a user input device. A tuning command may be configured from an interaction between the user input device and the one or more user-interface widget. Optionally, the user input device may include an audio capture device, and the tuning command may be configured from an audio signal carrying speech captured therewith. Optionally, the user input device may include a text input device, and the tuning command may be configured from a text signal carrying a command captured therewith. Optionally, the user input device may include a video capture device, and the tuning command is configured from a video signal carrying a gesture capture captured therewith.

In accordance with the first aspect, a calibration device for calibrating an autonomous agent is provided. The device may include one or more calibration processor configured to alter one or more teachable parameter of a teachable behavior model to reduce a difference between an observed behavior and a target behavior of an autonomous agent deployed in controlled environment and having the teachable behavior model assigned thereto, thereby calibrating the teachable behavior model into a calibrated behavior model.

In embodiments, the calibration device may include a calibration communication module, configured to receive an improvement objective. The target behavior may include the improvement objective.

In accordance with the first aspect, an evaluation device for evaluating an autonomous agent is provided. The device may include one or more evaluation processor and an evaluation communication module. The one or more evaluation processor may be configured to identify an improvement objective of an autonomous agent, deployed in a deployment environment, and having a teachable behavior model assigned thereto. The evaluation communication module may be configured to communicate the improvement objective.

In embodiments, the deployment environment may include interacting elements and the one or more evaluation processor may further be configured to identify an interacting element configuration from the interacting elements contributing to an observed interaction performance when the autonomous agent is deployed in the deployment environment. The interacting element configuration is used to configure one or more teaching fixture of a controlled environment thereby mimicking the interacting element configuration when the autonomous agent is deployed in the controlled environment.

In embodiments, the evaluation device may include a user input device. The user-interface module may include one or more user-interface widget, and a tuning command may be configured from an interaction between the user input device and the one or more user-interface widget. Optionally, the user input device may include an audio capture device and the tuning command may be configured from an audio signal carrying a speech captured therewith. Optionally, the user input device may include a text input device and the tuning command may be configured from a text signal carrying a command captured therewith. Optionally, the user input device may include a video capture device and the tuning command may be configured from a video signal carrying a gesture capture captured therewith.

In accordance with the first aspect, a non-transitory computer-readable medium storing a set of instructions for calibrating an autonomous agent is provided. The set of instructions may include one or more instructions that, when executed by one or more processors of a device, cause the device to define, from an uncalibrated behavior model adjusted by a plurality of model parameters, a teachable behavior model, the plurality of model parameters comprising one or more teachable parameter for transitioning an active state within a plurality of defined states. The set of instructions may also include one or more instructions that, when executed by one or more processors of a device, cause the device to calibrate the teachable behavior model attached to an autonomous agent deployed in a controlled environment, into a calibrated behavior model by altering the one or more teachable parameter to reduce the difference between an observed behavior and a target behavior until a difference therebetween is within a target threshold

In embodiments, the one or more instructions, when calibrating the teachable behavior model, may cause the device to receive an improvement objective. The target behavior may include the improvement objective.

In accordance with the first aspect, a non-transitory computer-readable medium storing a set of instructions for evaluating an autonomous agent is provided. The set of instructions may include one or more instructions that, when executed by one or more processors of a device, cause the device to identify an improvement objective of an autonomous agent, deployed in a deployment environment, and having a teachable behavior model assigned thereto. The set of instructions may also include one or more instructions that, when executed by one or more processors of a device, cause the device to communicate the improvement objective.

In embodiments, the deployment environment may include interacting elements and the set of instructions may include one or more instructions that, when executed by one or more processors of a device, cause the device to identify an interacting element configuration from the interacting elements contributing to an observed interaction performance when the autonomous agent is deployed in the deployment environment. The interacting element configuration may be used to configure one or more teaching fixture of a controlled environment thereby mimicking the interacting element configuration when the autonomous agent is deployed in the controlled environment.

In embodiments, the set of instructions may include one or more instructions that when executed by one or more processors of a device, cause the device to display a user-interface module with one or more user-interface widget. A tuning command may be configured from an interaction between a user input device and one or more user-interface widget. Optionally, the one or more user-interface widget may include a list of suggested commands, and the tuning command may be configured therefrom using the user input device. Optionally, the user input device may include an audio capture device, and the tuning command may be configured from an audio signal carrying a speech captured therewith. Optionally the user input device may include a text input device, and the tuning command may be configured from a text signal carrying a command captured therewith. Optionally, the user input device may include a video capture device, and the tuning command may be configured from a video signal carrying a gesture capture captured therewith.

In accordance with the first aspect, a method for calibrating an autonomous agent is provided. A teachable behavior model may be defined, from an uncalibrated behavior model adjusted by a plurality of model parameters. The plurality of model parameters may include an active state from a plurality of defined states and one or more teachable parameter for transitioning the active state within the plurality of defined states.

The teachable behavior model may be calibrated into a calibrated behavior model by assembling a controlled environment with one or more teaching fixture. The autonomous agent having the teachable behavior model assigned thereto may be deploying in the controlled environment. The one or more teachable parameter may be altered to reduce a difference between an observed behavior and a target behavior until the difference is within a target threshold.

In embodiments, the autonomous agent, having the teachable behavior model assigned thereto, may be deployed into an uncontrolled environment comprising interacting elements. An observed interaction performance of the autonomous agent with the interacting elements may be evaluated against a target interaction performance. An improvement objective may be identified, from the observed interaction performance and the target behavior may include the improvement objective.

In embodiments, an interacting element configuration contributing to the observed interaction performance may be identified and the interacting element configuration may be mimicked using the one or more teaching fixture.

In accordance with the first aspect, the autonomous agent may be an autonomous robot, the controlled environment may be development environment, and the uncontrolled environment may be an unmodified environment wherein the autonomous robot is intended to operate.

In embodiments, the autonomous agent may be a virtual actor in a digital media production, the controlled environment may be a virtual scene, and the uncontrolled environment may be a production scene.

In embodiments, the autonomous agent may be a non-playing character in a digital interactive production, the controlled environment may be a development scene, and the uncontrolled environment may be a production scene.

In embodiments, the autonomous agent may be a decision agent controlling one or more object of the controlled environment, the controlled environment may be a development scene, and the uncontrolled environment may be a production scene.

In embodiments, the uncalibrated behavior model comprises a decision system. Optionally, the decision system may include at least one of a Finite State Machine, a Markov Decision Process, a Decision Tree, a Behavior Tree, a Rule-Based System, a Utility System, a Graph-Based AI, and a Hierarchical Task Networks.

In embodiments, the one or more teachable parameter may include at least one of a preference score and a rule-based system for transitioning to the active state of the teachable behavior model within the defined states.

In embodiments, a tuning command with one or more contextual condition may be received by the calibration communication module or the user-interface module, from a training agent. A change to the one or more teachable parameter may be computed from the tuning command.

When received by the user-interface module, the tuning command may be communicated to a calibration device using the evaluation communication module.

In embodiments, an initial tuning command with at least one initial contextual condition may be received by the calibration communication module or the user-interface module, from the training agent. A tuning clarification request, related to the initial tuning command, may be communicated to the training agent. A tuning response with at least one additional contextual condition may be received, from the training agent. The tuning command may include the initial tuning command and the tuning response.

In embodiments, each teachable parameter from the one or more teachable parameter may be associated with a descriptive metadata, and the tuning command may be computed using the descriptive metadata.

In embodiments, the descriptive metadata may include a limit range and an observable effect description.

In embodiments, when receiving the tuning command, a selection from a list of suggested commands may be received. Optionally, the user-interface widget may include the list of suggested commands, and the tuning command may be configured therefrom using the user input device.

In embodiments, when receiving the tuning command, an event from a user-interface widget may be received.

In embodiments, when receiving the tuning command, an audio signal carrying speech may be received.

In embodiments, when receiving the tuning command, a text signal carrying a text command may be received.

In embodiments, when receiving the tuning command, a video signal carrying a gesture may be received.

In embodiments, while the autonomous agent is deployed in the controlled environment, the active state of the autonomous agent and capturing a context of the autonomous agent may be captured at a plurality of capture points in a timeline. The active state of the autonomous agent and the context of the of the autonomous agent from at least one historical point within the plurality of capture points may be included in at least one contextual condition from the one or more contextual condition.

In embodiments, the active state of the autonomous agent may include at least one of an ongoing action of the autonomous agent, a current objective of the autonomous agent, and a status of the autonomous agent.

### BRIEF DESCRIPTION OF THE DRAWINGS

Further features and exemplary advantages of the present invention will become apparent from the following detailed description, taken in conjunction with the appended drawings, in which:

FIG. 1 is a block diagram of an exemplary system for calibrating an autonomous agent, in accordance with the teachings of the present invention;

FIG. 2 is a block diagram of an exemplary autonomous agent, in accordance with the teachings of the present invention;

FIG. 3A, FIG. 3B and FIG. 3C referred together as FIG. 3, are drawings in which:

FIG. 3A depicts an exemplary system for calibrating a teachable behavior model of an autonomous robot when issuing a tuning command, in accordance with the teachings of the present invention;

FIG. 3B depicts an exemplary system for calibrating a teachable behavior model of an autonomous robot before updating the teachable behavior model of the autonomous robot, in accordance with the teachings of the present invention; and

FIG. 3C depicts an exemplary system for calibrating a teachable behavior model of an autonomous robot after updating the teachable behavior model of the autonomous robot, in accordance with the teachings of the present invention.

FIG. 4A and FIG. 4B, referred together as FIG. 4, are drawings, in which:

FIG. 4A depicts an exemplary system for calibrating a teachable behavior model of a virtual autonomous agent before issuing a tuning command, in accordance with the teachings of the present invention; and

FIG. 4B depicts an exemplary system for calibrating a teachable behavior model of a virtual autonomous agent after issuing a tuning command, in accordance with the teachings of the present invention;

FIG. 5 is a logical modular representation of a calibration module, part of an exemplary system, and deployed as a network node, in accordance with the teachings of the present invention;

FIG. 6 is a logical modular representation of an evaluation module, part of an exemplary system, and deployed as a network node, in accordance with the teachings of the present invention;

FIG. 7 is a flow chart of an exemplary method for calibrating an autonomous agent, in accordance with the teachings of the present invention;

FIG. 8 is a flow chart of an exemplary method for calibrating a teachable behavior model of an autonomous agent in a controlled environment, in accordance with the teachings of the present invention;

FIG. 9 is a sequence diagram of an exemplary method for calibrating an autonomous agent, in accordance with the teachings of the present invention;

FIG. 10 is a flow chart of an exemplary method for calibrating a teachable behavior model of an autonomous agent by mimicking interacting elements from an uncontrolled environment, in accordance with the teachings of the present invention;

FIG. 11 is a flow chart of an exemplary method for altering teachable parameters of a teachable behavior model of an autonomous agent, in accordance with the teachings of the present invention;

FIG. 12 is a flow chart of an exemplary method for altering teachable parameters of a teachable behavior model of an autonomous agent with feedback, in accordance with the teachings of the present invention;

FIG. 13 is a flow chart of an exemplary method for altering teachable parameters of a teachable behavior model of an autonomous agent with historical captures, in accordance with the teachings of the present invention;

FIG. 14 is a sequence diagram of an exemplary method for calibrating a teachable behavior model of an autonomous agent with historical captures, in accordance with the teachings of the present invention;

FIG. 15 is a block diagram of an exemplary context captured when altering teachable parameters of a teachable behavior model of an autonomous agent with historical captures, in accordance with the teachings of the present invention; and

FIG. 16 is a drawing of an exemplary system for calibrating a teachable behavior model of a virtual autonomous agent using a timeline for historical captures, in accordance with the teachings of the present invention.

### DETAILED DESCRIPTION

Autonomous agents may operate in dynamic environments by having decisions made based on sensory data and a teachable behavior model. In robotics, these autonomous agents may be deployed in tasks where efficiency, safety, and adaptability are required, such as those involving autonomous vehicles, drones, industrial robots, and service robots.

Calibrating an autonomous agent behavior model based on reinforcement learning and a large dataset of examples may result in unpredictable outcomes when presented with scenarios that fall outside of the training dataset. Reinforcement learning techniques also tend to make it difficult to adjust specific behaviors, since adding new samples to the training dataset to adjust specific behaviors may disrupt other behaviors. In addition, the models trained with reinforcement leaning often provide poor traceability, making it difficult to debug and improve. While scripting-based techniques may provide better traceability, a complex set of rules may require significant technical expertise and may result in models that become difficult to maintain as the number of rules and conditions increases to support complex behaviors. Choosing an adequate calibrating methodology may be challenging in robotics, where precise, reliable and yet complex behavior models may be essential for safe and effective operations.

Even seemingly simple devices may benefit from advanced behavior models. For instance, a smart lighting system can dim lights in the evening or turn them off when no one is present. A smart irrigation system can adjust watering schedules based on recent rainfall or soil moisture levels, while a home security system may activate alarms or send alerts in specific circumstances. Energy management systems can optimize power consumption according to user preferences and utility rates, and fitness trackers might be calibrated to focus on daily step goals or morning stretching. Smart ovens can automatically preheat to the desired temperature and cook food to a preferred doneness, while smart TVs or audio systems can adapt content playback based on user routines. Healthcare monitoring devices can provide personalized health alerts, and cleaning robots can tailor their cleaning strategies to household needs.

Although some of these use cases may be implemented through pre-programmed routines, updating or adding new scenarios typically require software modifications or hardware changes, limiting adaptability.

In embodiments, virtual autonomous agents may serve purposes analogous to that of autonomous robots. Virtual autonomous agents may appear as computer-controlled characters or environmental systems that simulate human-like or context-based intelligence, interacting with players and the game world. Virtual autonomous agents may range from simple scripted behaviors to complex algorithms that adapt to player actions, thereby contributing to more immersive gameplay.

In filmmaking, virtual autonomous agents may be used to control virtual actors, especially in scenes involving crowds or animated creatures. Behavioral simulation may allow for realistic interactions with environments and other characters. A virtual autonomous agent might manage a flock or a large group of extras, ensuring consistent, context-appropriate responses.

Broadly speaking, modifying the behavior of autonomous agents across robotics, entertainment, and consumer devices is often desirable. Teachable behavior models support this by exposing teachable parameters that allow users or developers to calibrate underlying decision-making processes.

In accordance with the first aspect, the autonomous agent may be an autonomous robot, the controlled environment may be a development environment, and the uncontrolled environment may be an unmodified environment wherein the autonomous robot is intended to operate.

In embodiments where the autonomous agent is a virtual actor in a digital media production, the controlled environment may be a virtual scene, and the uncontrolled environment may be a production scene. In embodiments where the autonomous agent is a non-playing character in a digital interactive production, the controlled environment may be a development scene, and the uncontrolled environment may be a production scene. In embodiments, where the autonomous agent may be a decision agent controlling one or more object of the controlled environment, the controlled environment may be a development scene, and the uncontrolled environment may be a production scene.

A teachable behavior model may consist of a single model or a hierarchy. When the teachable behavior model is designed as a hierarchy of models, different models may apply to different contexts (e.g., a model of operations during the day and another for operation during the night) or operate concurrently, blending or voting on possible outcomes. A hierarchical design supports reusability, such as combining a basic navigation model with an overriding task-specific model for obstacle avoidance.

Calibrating an autonomous agent in a video game context may involve fine-tuning behaviors for enemies, allies, or neutral non-player characters (NPCs). Adjustments may ensure an appropriate difficulty level or more engaging interactions, thereby aligning the responses of the autonomous agent with the narrative or design goals of the video game. In filmmaking, an autonomous agent may be calibrated to exhibit distinct reactions for different emotional or environmental conditions, enabling realistic crowd simulations and dynamic group scenes.

Beyond robotics and entertainment, autonomous agents technology may apply to everyday intelligent devices, including watches, smartphones, and home assistants. By exposing one or more teachable parameter for adjustment, these systems may be customized to meet individual preferences without the need for complete system overhauls. The model of the autonomous agent may govern objects or systems within a controlled environment or an uncontrolled environment rather than characters. For instance, in a video game, an autonomous agent may be used to manage defense mechanisms or spawn specific types of enemies or items, ensuring balanced and engaging gameplay.

In scenarios where multiple behavior models exist, the context may dictate the selection or concurrent operation of these behavior models. In a game featuring numerous Non-Player Characters (NPCs), a shared teachable behavior model may be supplemented by overriding behavior models wherewith enhanced combat capabilities or special traits for certain NPC types may be introduced, thereby making the system adaptable and manageable.

While the current disclosure focuses on the deployment of a single autonomous agent to a controlled environment or uncontrolled environment, skilled persons will readily understand that multiple autonomous agents may be deployed simultaneously, and the simplification is strictly for the purpose of illustrating the invention.

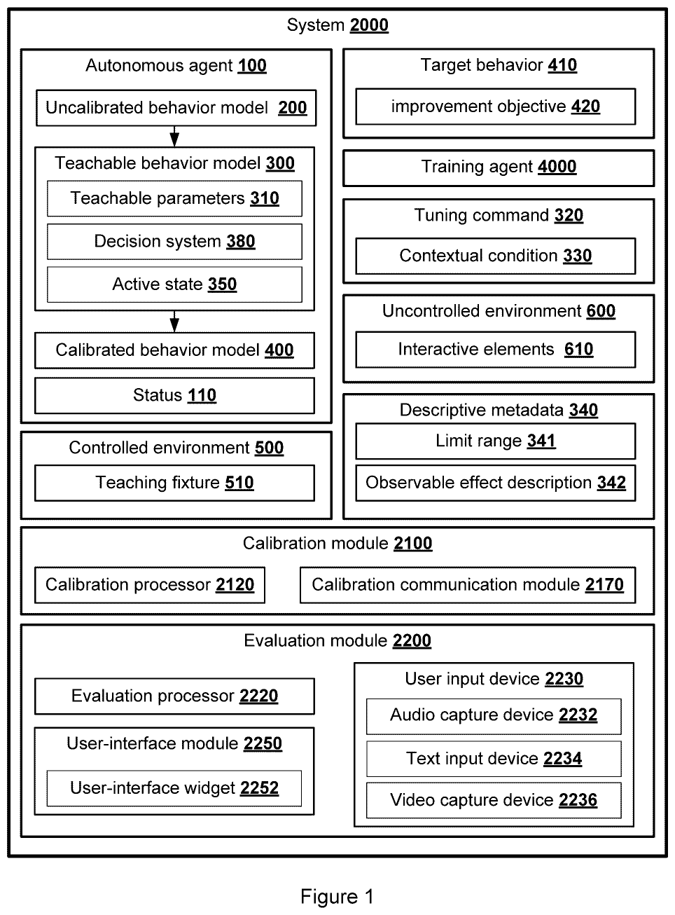

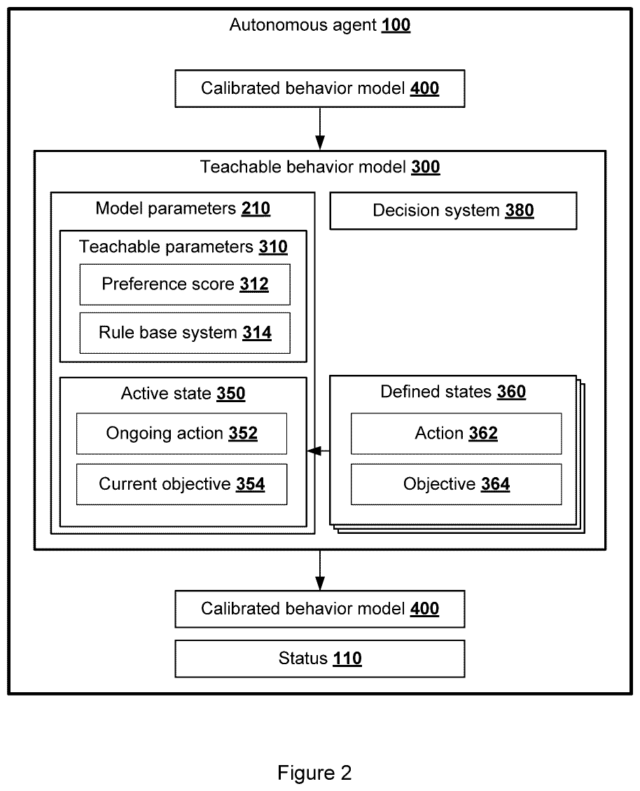

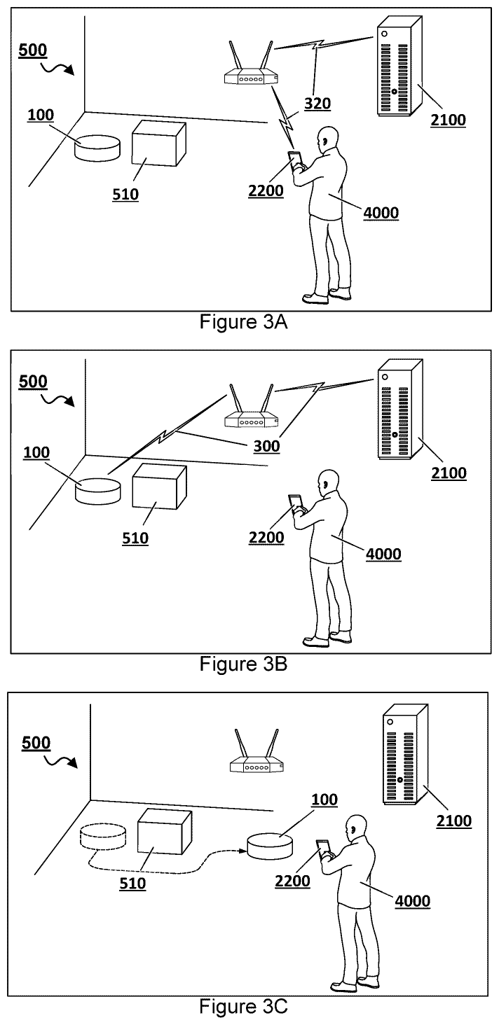

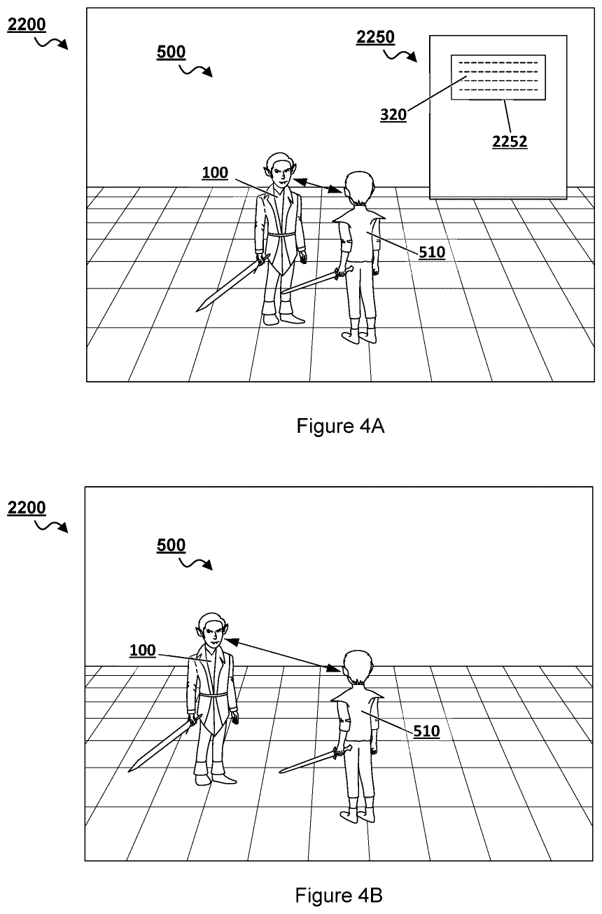

A first aspect of the teachings presented herein relates to a system for calibrating a teachable behavior model. Reference is now made to the drawings in which FIG. 1 is a block diagram depicting an exemplary system 2000 for calibrating an autonomous agent 100, in accordance with the teachings of the present invention and FIG. 2 is a block diagram depicting an exemplary autonomous agent 100. Reference is also made to the drawings of FIG. 3A, FIG. 3B and FIG. 3C referred together as FIG. 3, and FIG. 4A and FIG. 4B, referred together as FIG. 4. The drawings of FIG. 3 depict an exemplary system 2000 for calibrating a teachable behavior model 300 of an autonomous robot when issuing a tuning command 320 (FIG. 3A), before updating the teachable behavior model 300 of the autonomous robot (FIG. 3B), and after updating the teachable behavior model 300 of the autonomous robot (FIG. 3C),, in accordance with the teachings of the present invention. The drawings of FIG. 4 depict an exemplary system 2000 for calibrating a teachable behavior model 300 of a virtual autonomous agent before issuing a tuning command 320 (FIG. 4A), and after issuing a tuning command 320 (FIG. 4B), in accordance with the teachings of the present invention.

The autonomous agent 100 with a teachable behavior model 300 assigned thereto may be included in the system 2000 and the teachable behavior model 300 may be adjusted by altering the teachable parameters 310 thereof. In the context of artificial intelligence, behavior models may process inputs, such as data or environmental stimuli, to produce outputs in the form of decisions or actions. The teachable behavior model 300 may operate in a structured manner, often relying on predefined rules or learned patterns to determine an appropriate response to a given situation.

The response from the teachable behavior model 300 may be obtained from decision system 380, an active state 350 from a plurality of defined states 360, and the teachable parameters 310. Different embodiments of the decision systems 380 may be useful according to the specific context, such as Finite State Machines, Markov Decision Processes, Decision Trees, Behavior Trees, Rule-Based Systems, Utility Systems, Graph-Based AI, and Hierarchical Task Networks.

The teachable behavior model 300 may be an enhanced version of an uncalibrated behavior model 200 that has been adapted to facilitate calibration and iterative refinement. The uncalibrated behavior model 200 may be used in a device or production that has not yet been adapted for the method 1000 disclosed herein. Transforming an uncalibrated behavior model into a teachable behavior model 300 may involve adding descriptive metadata 340 to the model. The descriptive metadata 340 may include attributes such as limit ranges, observable effect descriptions, and context-related conditions. The descriptive metadata 340 may provide a framework for understanding parameters that may be adjusted and expected outcomes of adjustments. By incorporating descriptive metadata 340, the teachable behavior model 300 may become accessible for calibration, allowing fine-tuning in controlled or uncontrolled environments to meet specific behavioral objectives.

In a video game context where autonomous agents 100 act as Non-Player Characters (NPCs), a teachable parameter 310 may relate to the level of aggression. This teachable parameter 310 may control the frequency with which an NPC engages in combat or reacts aggressively towards a player. Adjusting this teachable parameter 310 may balance the difficulty of interaction, aligning the NPC behavior with a desired challenge level of a game. For an autonomous robot that navigates physical spaces, a teachable parameter 310 may govern the sensitivity of the robot to obstacles, such as walls or furniture. Altering this teachable parameter 310 may impact the propensity of the robot to take alternative routes or slow down when approaching obstacles. In digital media production, a teachable parameter 310 may relate to a radius of attention, within which collaborating objects may cause a virtual actor to react.

The teachable parameter 310 may include a preference score 312 embodied as a single-valued parameter, such as a constant value, which may be increased or decreased during calibration. In alternative embodiments, the preference score 312 may be embodied as an option within a finite set of options, which may be changed during calibration, or as a boolean parameter, which may be toggled on or off during calibration. The preference score 312 would typically not rely on sensor data or other forms of input data. In contrast, rule-based systems 314, when utilized as the teachable parameter 310, may encompass state machines and transfer functions that provide different outputs based on provided inputs. The calibration process for rule-based systems 314 may involve adding or modifying internal states, updating entries in a table utilized in a transfer function, or updating scripts or code that may be executed to evaluate the input parameters.

The autonomous agent 100 may exist within an active state 350 at any point in time, which may include at least one of an ongoing action 352, a current objective 354, and a status 110. Ongoing actions 352 may involve tasks or activities being executed by the autonomous agent 100. For instance, ongoing actions 352 of a robotic vacuum may involve navigating a room or vacuuming a specific section of carpet. In a video game, ongoing actions 352 may include actions such as walking, attacking, or using an item. Current objectives 354 may represent goals that the autonomous agent 100 seeks to achieve, which may guide and prioritize actions undertaken based on the environment or circumstances. For example, the current objective 354 of a robotic vacuum may include cleaning an entire floor level of a building. In a digital game scenario, the current objective 354 of a non-player character may involve locating and interacting with a player character.

A teachable behavior model 300 may include an active state 350 selected from a plurality of defined states 360, wherewith the autonomous agent 100 may operate in pre-programmed behavior states. Each state from the plurality of defined states 360 may correspond to a specific condition or mode of operation for the autonomous agent 100, such as navigating, performing a task, or remaining idle. In an autonomous vacuum robot, the plurality of defined states 360 may include states such as ‘cleaning’, ‘charging’, ‘navigating’, and ‘idle’. The active state 350 may transition between these states based on current tasks or battery levels. In a video game context, a non-player character may exist in defined states 360 such as ‘patrolling’, ‘engaged in combat’, or ‘fleeing’, with the active state 350 representing the character behavior in real-time, considering player actions or environmental factors. Transitions between these states may be enabled by altering one or more teachable parameters 310, wherewith the decision-making process of the teachable behavior model 300 is guided, thereby allowing the autonomous agent 100 to adapt dynamically to stimuli or objectives present in its environment.

The ongoing action 352 of the autonomous agent 100 may be selected from pre-defined actions 362. The pre-defined actions 362 may consist of a set of tasks or activities that are delineated prior to the deployment of the autonomous agent 100. Examples of pre-defined actions 362 may include movement commands like walking, running, or crouching, or interaction commands such as picking up objects, opening doors, or initiating dialogues. Each of the pre-defined actions 362 may be associated with a particular set of conditions or triggers defined within the teachable behavior model 300, ensuring that the autonomous agent 100 performs the correct action in response to specific stimuli or states.

Current objectives 354 of the autonomous agent 100 may correspond to pre-defined objectives 364, wherewith various goals or endpoints for the autonomous agent 100 during operation are encompassed. Pre-defined objectives 364 may range from simple tasks such as reaching a particular location to more complex goals like completing a mission composed of multiple steps. In the context of a video game, a pre-defined objective 364 may involve a non-player character retrieving a certain item or engaging in a strategic battle, dictated by the game's storyline or mechanics. Within the scope of an autonomous robot, a pre-defined objective 364 may entail completing a cleaning cycle or delivering a package. By specifying pre-defined objectives 364, programmers may ensure that the autonomous agent 100 has clear targets toward which actions and behaviors may be directed, thereby facilitating a structured approach to fulfilling operational requirements.

The teachable parameter 310 may be used for transitioning the active state 350 within the plurality of defined states 360. Transitioning to an updated active state 350, setting a new ongoing action 352, or updating a current objective 354 may involve an evaluation of the current active state 350, the current ongoing action 352, and the current objective 354 using the decision system 380. Therewith, the evaluation may be conducted according to the teachable parameter 310 and based on input that may include data such as the status 110 of the autonomous agent 100, measurements from physical or virtual sensors, and environmental data such as time and location.

The status 110 of the autonomous agent 100 may be determined by parameters relevant to current conditions. For an autonomous robot, parameters such as present energy level and weight of a payload being carried may be included in the status 110. For a virtual autonomous agent 100, the status 110 may encompass parameters including health and fear level, thereby influencing the decision-making process of the autonomous agent 100 within the operation environment of the autonomous agent 100.

The teachable behavior model 300 of the autonomous agent 100 may be calibrated 1200 by the system 2000 through alteration 1300 of the teachable parameters 310 until the teachable behavior model 300 transitions into a calibrated behavior model 400 aligning with a target behavior 410. The calibration process may be executed iteratively with a calibration module 2100, wherein the autonomous agent 100 may be deployed 1220 into a controlled environment 500. The controlled environment 500 may comprise one or more teaching fixture 510, wherewith the behavior of the autonomous agent 100 may be observed and validated.

The controlled environment 500 may be a staged scene or a configuration specially designed for calibrating behavior models. The controlled environment 500 may comprise an autonomous agent 100 and teaching fixtures 510.

When the autonomous agent 100 is a virtual autonomous agent 100, the controlled environment 500 may consist of a virtual scene wherein the teaching fixtures 510 are designed to trigger various behaviors therefrom. In a video game context, the controlled environment 500 may be instantiated as a specific scene within the game or as a development-specific scene commonly referenced as a “gym”, constructed to test the autonomous agent 100. Within the controlled environment 500, the teaching fixtures 510 may be configured with sensors and triggers to monitor, inspect, or interact with the autonomous agent 100. Furthermore, the teaching fixtures 510 may include teaching widgets within the user-interface widget 2252 provided through a user-interface module 2250, enabling interactions with the controlled environment 500, the autonomous agent 100, and the teaching fixtures 510. For example, within a virtual environment, the teaching fixtures 510 may facilitate debug options that are unavailable in an uncontrolled environment 600. In scenarios where the autonomous agent 100 is an autonomous robot, the controlled environment 500 may be constituted by a physical environment where the teaching fixtures 510 comprise sensors installed to monitor and capture measurements during calibration sessions. The teaching fixtures 510 within the controlled environment 500 may encompass static objects such as obstacles and dynamic objects available for interaction. The teaching fixtures 510 may also encompass other characters driven interactively by a training agent 4000 or propelled autonomously based on another behavior model. Additionally, the teaching fixtures 510 may involve other environment properties, including temperature, weather conditions, and time of day.

In one embodiment, a virtual scene may be used as the controlled environment 500 wherein a virtual autonomous agent 100 with a teachable behavior model 300 attached thereto may simulate a physical autonomous robot. The virtual autonomous agent 100 may be configured to simulate the functionality of the physical autonomous agent 100, and the virtual scene may be configured to replicate the physical properties of a physical scene. The use of a virtual scene for calibrating the physical autonomous agent 100 may facilitate the processing of multiple calibration steps concurrently. Furthermore, the use of a virtual scene may mitigate potential physical risks associated with accidents during the calibration process.

When the controlled environment 500 with teaching fixtures 510 is provided, the environment may permit manifestations of the teachable behavior model 300 to be observed predictably and repeatedly. In one embodiment, the controlled environment 500 may be a specially designed environment with teaching fixtures 510 configured to trigger the manifestation of certain aspects of the teachable behavior model 300. In another embodiment, the controlled environment 500 may be a specific location of a larger environment selected due to a particular arrangement existing therein.

The calibration module 2100 may be embodied as a calibration device 2100 for calibrating an autonomous agent 100. The calibration module 2100 may include one or more calibration processor 2120 wherewith the alteration 1300 of one or more teachable parameter 310 may be configured to reduce a difference between an observed behavior and a target behavior 410, thereby calibrating 1200 the teachable behavior model 300 of the autonomous agent 100 into a calibrated behavior model 400.

In embodiments, the calibration module 2100 is implemented using a non-transitory computer-readable medium

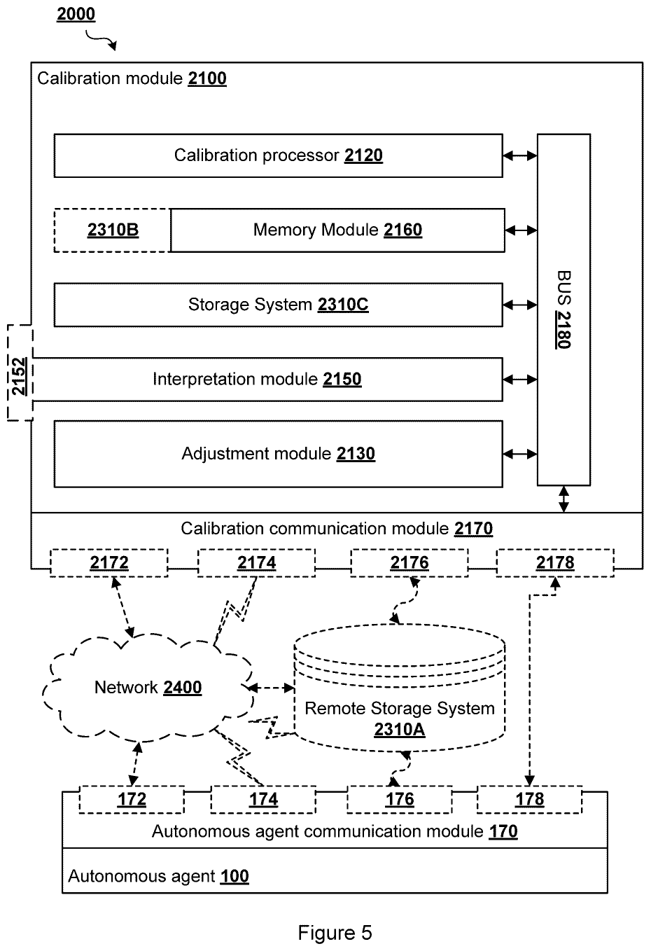

Reference is now made to the drawings in which FIG. 5 is a logical modular representation depicting a calibration module, part of an exemplary system, and deployed as a network node in a network 2400, in accordance with the teachings of the present invention. The calibration module 2100 comprises a memory module 2160, a calibration processor 2120, an adjustment module 2130, and a calibration communication module 2170 as a network interface module. The networked calibration module 2100 may also include an interpretation module 2150.

The system 2000 may comprise a storage system 2310A, 2310B, and 2310C, referred together as 2310, for storing and accessing long-term (i.e., non-transitory) data and may further log data while the calibration module 2100 is being used. FIG. 5 shows examples of the storage system 2310 as a distinct database system 2310A, a distinct module 2310C of the calibration module 2100 or a sub-module 2310B of the memory module 2160 of the calibration module 2100. The storage system 2310 may be distributed over different systems 2310A, 2310B, 2310C. The storage system 2310 may comprise one or more logical or physical as well as local or remote hard disk drive (HDD) (or an array thereof). The storage system 2310 may further comprise a local or remote database made accessible to the calibration module 2100 by a standardized or proprietary interface or via the calibration communication module 2170.

The calibration communication module 2170 represents at least one physical interface that can be used to communicate with other network nodes. The calibration communication module 2170 may be made visible to the other modules of the calibration module 2100 through one or more logical interfaces. The actual stacks of protocols used by the physical network interface(s) and/or logical network interface(s) 2172, 2174, 2176, and 2178 of the calibration communication module 2170 do not affect the teachings of the present invention.

The calibration processor 2120 may represent a single processor with one or more processor cores or an array of processors, each comprising one or more processor cores. The memory module 2160 may comprise various types of memory (different standards or kinds of Random Access Memory (RAM) modules, memory cards, Read-Only Memory (ROM) modules, programmable ROM, etc.).

A bus 2180 is depicted as an example of means for exchanging data between the different modules of the calibration module 2100. The teachings presented herein are not affected by the way the different modules exchange information. For instance, the memory module 2160 and the calibration processor 2120 could be connected by a parallel bus, but could also be connected by a serial connection or involve an intermediate module (not shown) without affecting the teachings of the present invention.

The adjustment module 2130 may allow the calibration module 2100 to deliver adjustment-related services whereby the one or more teachable parameter 310 of the teachable behavior model 300 may be modified. The interpretation module 2150 may provide interpretation-related services whereby descriptive metadata 340 and additional context data may be analyzed to assist calibration processes through informed evaluation of inputs, thereby permitting the calibration module 2100 to calibrate 1200 the teachable behavior model 300 into a calibrated behavior model 400.

The adjustment module 2130 may be used to alter 1300 the teachable parameters 310 within the teachable behavior model 300 of the autonomous agent 100. The adjustment module 2130 may contribute to modifying teachable parameters 310 as part of the calibration process 1200, aligning outputs of the autonomous agent 100 with the target behavior 410. Data from observed behaviors may be utilized by the adjustment module 2130 to modify numerical values such as preference scores 312, alter rules within rule-based systems 314, or reconfigure decision-making algorithms of the decision system 380 to meet predefined criteria or objectives.

The calibration module 2100 may communicate the modified teachable parameters 310 and/or an updated teachable behavior model 300 to the autonomous agent 100 through an autonomous agent communication module 170 of the autonomous agent 170. In embodiments, communication between the calibration communication module 2170 and the autonomous agent communication module 170 may be achieved directly through direct connection 2178 and 178, which may be between two distinct devices or internal to a single device when the calibration module 2100 and the autonomous agent 170 are comprised within the same device, across the network 2400 through wired interfaces 2172 and 172, or wireless interfaces 2174 and 174. In one embodiment, communication may be achieved across a remote storage system 2310A through respective I/O interface 2176 and 176 of the calibration module 2100 and the autonomous agent 100.

The interpretation module 2150 may be used to interpret external inputs such as a tuning command 320 and a contextual condition 330 and translate them into actionable data that informs adjustments to the teachable behavior model 300. The interpretation module 2150 may be responsible for processing commands issued by a training agent 4000, which are communicated through the calibration communication module 2170, and subsequently generating meaningful modifications to the teachable parameter 310 based on this interpretation. Descriptive metadata 340 associated with each teachable parameter 310 may be utilized by the interpretation module 2150 to interpret instructions and apply coherent adjustments aligning with the intended operational framework of the autonomous agent 100.

The interpretation module 2150 may be complemented by an external interpretation module 2152, wherewith the interpretation of inputs requiring advanced computational techniques or exhibiting high complexity may be facilitated. Such specialization provided by the external interpretation module 2152 may allow for interpreting inputs using large models, such as neural networks or other machine learning models with a significant number of parameters, utilized in contemporary artificial intelligence applications. The external interpretation module 2152 may enable the handling of sophisticated inputs, thereby enhancing the calibration process of the autonomous agent 100 by processing complex data inputs into actionable insights.

The external interpretation module 2152 may be utilized by the interpretation module 2150 to manage complex input signals or commands requiring computationally intensive methods, potentially enabling the system 2000 to employ advanced AI capabilities without burdening the internal configuration of the interpretation module 2150. The external interpretation module 2152 may offer access to a broader array of model interpretations and may facilitate the conversion of complex inputs into actionable data, thereby ensuring that the calibration module 2100 alters 1300 one or more teachable parameter 310 consistently with nuanced inputs and sophisticated decision-making models. The integration of the external interpretation module 2152 may potentially enhance the adaptability and precision of the system 2000, thereby ensuring alignment between autonomous agents 100 and their respective environments.

The adjustment module 2130 and the interpretation module 2150 may collaborate to ensure that adjustments to the teachable parameter 310 are made efficiently and are grounded in an understanding of the commands and contexts from which those adjustments originate. The dual-module functionality may serve to refine and calibrate the teachable behavior model 300 such that the autonomous agent 100 may perform in both the controlled environment 500 and the uncontrolled environment 600.

Variants of the calibration processor 2120, memory module 2160, and calibration communication module 2170 for use within the calibration module 2100 may be understood by skilled individuals. The adjustment module 2130, memory module 2160, interpretation module 2150, and calibration processor 2120 may be recognized in their application with other modules of the calibration module 2100 for executing elements of the calibration process 1200, even if not explicitly referenced in described examples.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

The autonomous agent 100 may be connected using the calibration communication module 2170 and a similar communication module on the autonomous agent 100, wherewith updates to the teachable parameter 310 or updates to the teachable behavior model 300 may be communicated thereto.

The alteration 1300 of the one or more teachable parameter 310 may encompass the modification or adjustment of the parameters within the teachable behavior model 300 of an autonomous agent 100. This process may involve changing numerical values such as a preference score 312, updating rules within a rule-based system 314, or modifying the structure of decision-making algorithms utilized by the decision system 380. These modifications may aim to achieve a performance from the autonomous agent 100 that aligns more closely with specific objectives or scenarios envisioned for deployment.

The target behavior 410 may represent the desired behaviors or actions that the autonomous agent 100 is expected to exhibit. This target behavior 410 may serve as a benchmark or goal against which the current behavior of the autonomous agent 100 may be compared. Defining the target behavior 410 may involve outlining specific criteria or performance metrics that the autonomous agent 100 should meet or emulate, which may include precise actions, reactions to specific stimuli, efficiency in completing tasks, or the fulfillment of strategic objectives within the environment of the autonomous agent 100.

The observed behavior of the autonomous agent 100 within a given environment, whether a controlled environment 500 or an uncontrolled environment 600, may involve the real-time performance or actions thereof. Observation may be conducted through various means contingent on the specific context. In a controlled environment 500, sensors and teaching fixtures 510 may be utilized to monitor the autonomous agent 100. In a digital setting, such as a video game, the system may track in-game actions of the autonomous agent 100. The observed behavior may entail the collection of data concerning movement, reaction, interaction, or task performance of the autonomous agent 100 in relation to external stimuli or environmental conditions encountered therein.

A difference between an observed behavior and a target behavior 410 may be reduced by adjusting the teachable parameters 310 of the teachable behavior model 300 such that actions of the autonomous agent 100 become progressively aligned with a desired performance as described by the target behavior 410. This adjustment may be achieved through an iterative process, where observed behavior is monitored, and teachable parameters 310 are methodically altered 1300, utilizing techniques such as trial and error or algorithmic optimization, until the behavior of the autonomous agent 100 aligns within a target threshold of the target behavior 410. Thereby, the autonomous agent 100 may behave with increased precision and reliability in intended applications.

The system 2000 may further rely on an uncontrolled environment 600. The uncontrolled environment 600 may generally refer to an environment for which the autonomous agent 100 is actually being designed. An uncontrolled environment 600 may include interacting elements 610 that may be configured to interact with the autonomous agent 100 but may not be configured such that specific aspects of the teachable behavior model 300 are highlighted when doing so. For the case of an autonomous vacuum cleaner, the interacting elements 610 in an uncontrolled environment 600 might include various floor types, furniture placements, and regular household obstructions. Alternatively, in a video game context, interacting elements 610 for a virtual actor controlled by an autonomous agent 100 could include challenges such as adversaries programmed with unique tactics or dynamic environmental changes within the game world. The uncontrolled environment 600 may refer to the actual production scenes of the video game, designed for end-user gameplay.

The evaluation module 2200 with one or more evaluation processor 2220 may allow for the identification 1260 of an improvement objective 420 when the autonomous agent 100 is deployed 1240 in the uncontrolled environment 600. When a physical object is being observed, the evaluation module 2200 may be embodied as a portable computer or a mobile device configured for monitoring the autonomous agent 100. When the autonomous agent 100 is deployed 1240 within a virtual scene, the evaluation module 2200 may be integrated with the virtual scene simulation, or may operate remotely from the virtual scene simulation. Independently, the evaluation module 2200 may serve as an evaluation device 2200 for evaluating an autonomous agent 100.

The evaluation module 2200 may be used for autonomous agents 100 deployed in deployment environment, which may include uncontrolled environments 500 and controlled environments 600. When the deployment environment is a controlled environment, the interacting elements 610 may include teaching fixtures 510. In embodiments, the evaluation module 2200 is implemented using a non-transitory computer-readable medium.

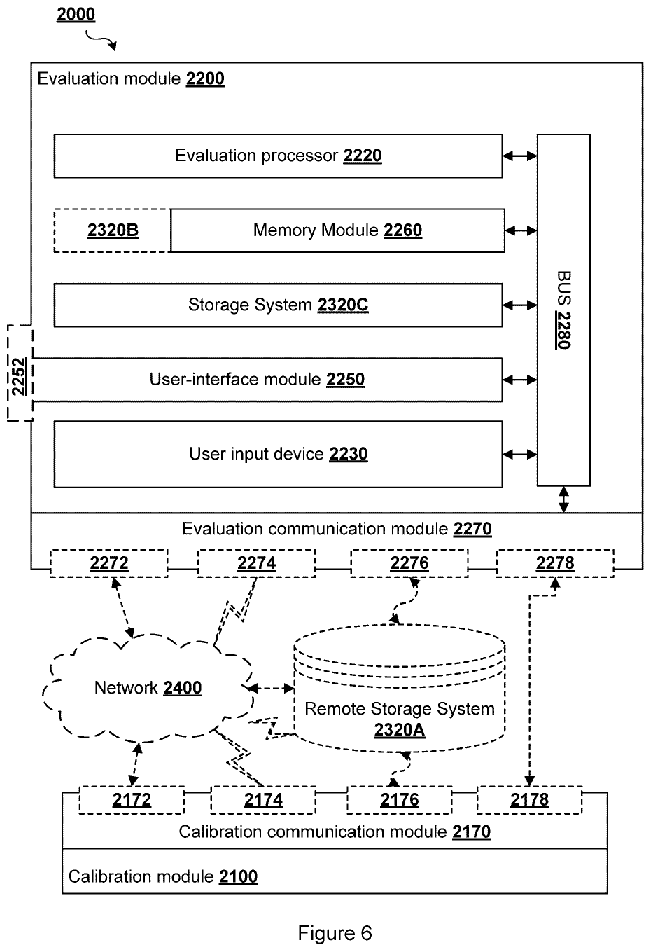

Reference is now made to the drawings in which FIG. 6 is a logical modular representation depicting an evaluation module, part of an exemplary system, and deployed as a network node in a network 2400, in accordance with the teachings of the present invention. The evaluation module 2200 comprises a memory module 2260, an evaluation processor 2220, a user input device 2230 and an evaluation communication module 2270. The evaluation module 2200 may also include a user interface module 2150.

The system 2000 may comprise a storage system 2320A, 2320B and 2320C, referred together as 2320, for storing and accessing long-term (i.e., non-transitory) data and may further log data while the evaluation module 2200 is being used. FIG. 6 shows examples of the storage system 2320 as a distinct database system 2320A, a distinct module 2320C of the evaluation module 2200 or a sub-module 2320B of the memory module 2260 of the evaluation module 2200. The storage system 2320 may be distributed over different systems 2320A, 2320B, 2320C. The storage system 2320 may comprise one or more logical or physical as well as local or remote hard disk drive (HDD) (or an array thereof). The storage system 2320 may further comprise a local or remote database made accessible to the evaluation module 2200 by a standardized or proprietary interface or via the evaluation communication module 2270.

The evaluation communication module 2270 represents at least one physical interface that can be used to communicate with other network nodes. The evaluation communication module 2270 may be made visible to the other modules of the evaluation module 2200 through one or more logical interfaces. The actual stacks of protocols used by the physical network interface(s) and/or logical network interface(s) 2272, 2274, 2276 and 2278 of the evaluation communication module 2270 do not affect the teachings of the present invention.

The evaluation processor 2220 may represent a single processor with one or more processor cores or an array of processors, each comprising one or more processor cores. The memory module 2260 may comprise various types of memory (different standardized or kinds of Random Access Memory (RAM) modules, memory cards, Read-Only Memory (ROM) modules, programmable ROM, etc.).

A bus 2280 is depicted as an example of means for exchanging data between the different modules of the evaluation module 2200. The teachings presented herein are not affected by the way the different modules exchange information. For instance, the memory module 2260 and the evaluation processor 2220 could be connected by a parallel bus, but could also be connected by a serial connection or involve an intermediate module (not shown) without affecting the teachings of the present invention.

A user input device 2230 provides input-related services to the evaluation module 2200, which will be described in more details hereinbelow, while the user-interface module 2250 provides a graphical interface for a training agent 4000 to interact with. In embodiments, the user-interface module 2250 with user-interface widget 2252 may be provided by the evaluation module 2200. The user-interface module 2250 may display the user-interface widget 2252 locally on a display device or remotely using a backend-frontend configuration.

The evaluation module 2200 may communicate the tuning command 320 to the calibration module 2100 through the calibration communication module 2170 of the calibration module 2100. In embodiments, communication between the evaluation module 2200 and the calibration communication module 2170 may be achieved directly through direct connection 2278 and 2178, which may be between two devices or internal to a single device, across the network 2400 through wired interfaces 2272 and 2172, or wireless interfaces 2274 and 2174. In one embodiment, communication may be achieved across the remote storage system 2320A using respective I/O interfaces 2276 and 2176 of the evaluation module 2200 and the calibration module 2100.

Variants of the evaluation processor 2220, memory module 2260, and evaluation communication module 2270 may be used within the present invention in diverse configurations as understood by skilled individuals. The user input device 2230, memory module 2260, user-interface module 2250, and evaluation processor 2220 may be utilized with other modules of the evaluation module 2200 for executing both conventional and novel elements described herein.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

The calibration module 2100 may be connected with the evaluation module 2200 using a calibration communication module 2170 and an evaluation communication module 2270 for communicating the improvement objective 420.

The calibration communication module 2170 and the evaluation communication module 2270 may be interfaces connecting the calibration module 2100 with other components of the system 2000. When operating in a remote setting, these modules may employ network devices to facilitate communication over a digital network, such as the Internet or a local area network (LAN). In such a configuration, the calibration communication module 2170 may utilize protocols such as TCP/IP, HTTP, or REST API to transmit calibration data and receive relevant information from other network nodes.

In contrast, when the modules are deployed in close physical proximity, such as within the same computing device or circuit board, the calibration communication module 2170 may utilize a memory bus to facilitate data exchange. A memory bus refers to an internal pathway within a computing system that allows data to flow between the CPU, memory, and other components. In this context, the module may communicate via direct memory access (DMA) or other similar protocols to efficiently handle data transfer without the latency associated with network-based communication.

When an improvement objective 420 may be communicated to the calibration module 2100, the target behavior 410 may include the improvement objective 420. The improvement objective 420 may be taken into consideration once the autonomous agent 100 may be deployed into the controlled environment 500.

Deploying 1220 the autonomous agent 100 in the controlled environment 500 or deploying 1240 the autonomous agent 100 in the uncontrolled environment 600 may involve a separate instance of the autonomous agent 100 with the same teachable behavior model 300 attached thereto.

The one or more evaluation processor 2220 may be configured to identify 1270 an interacting element configuration from interacting elements 610 that contribute to an observed interaction performance when the autonomous agent 100 is deployed 1240 in the uncontrolled environment 600. The one or more teaching fixture 510 may be configured to mimic 1212 the interacting element configuration when the autonomous agent 100 is deployed 1220 in the controlled environment 500.

The observed interaction performance may refer to the actions or reactions displayed by the autonomous agent 100 in response to interacting elements 610. By identifying which specific configuration of interacting elements 610 may affect the behavior of the autonomous agent 100, the one or more evaluation processor 2220 may pinpoint what aspects of the environment need to be replicated for further analysis or training.

In a controlled environment 500, where conditions may be precisely managed and adjusted, the identified interacting element configuration may be mimicked 1212 using one or more teaching fixture 510. The teaching fixture 510 may be devised to recreate or simulate specific conditions or scenarios to facilitate training or calibration of the autonomous agent 100. Thereby, the observed impact of the interacting elements 610 on the autonomous agent 100 may be reproduced within the controlled environment 500 to allow for detailed study or calibration of the behavior of the autonomous agent 100 in response to those specific conditions.

The use of the teaching fixture 510 may allow targeted calibration or refinement of the autonomous agent 100 by enhancing performance or adjusting behavior to specific interaction scenarios observed in the uncontrolled environment 600. An iterative calibration process may be facilitated by simulating real-world conditions within a controlled setting, thereby assisting in fine-tuning the teachable behavior model 300 of the autonomous agent 100.

The evaluation module 2200 may incorporate a user-interface module 2250, wherewith a user-interface widget 2252 may be included. The user-interface widget 2252 may serve as elements of a graphical user interface enabling interaction with the system 2000. The user-interface widget 2252 may represent controls such as buttons, sliders, checkboxes, or dropdown menus facilitating interaction within the interface and input reception from a training agent 4000. A user input device 2230 may also be encompassed within the evaluation module 2200. The user input device 2230 may enable command or data input into the system 2000 and may include various devices for capturing diverse input forms. Interaction between the user input device 2230 and the user-interface widget 2252 may configure a tuning command 320, therewith providing calibration or adjustment directives for the teachable behavior model 300 of the autonomous agent 100 based on user input and feedback from the system 2000.

The user input device 2230 may include an audio capture device 2232, wherewith the tuning command 320 may be configured from an audio signal carrying a speech captured therewith. The audio capture device 2232 may be designed to encompass microphones capable of detecting and capturing sound waves, converting the sound waves into electrical signals for processing by computing systems. Examples of the audio capture device 2232 may encompass built-in microphones in devices such as smartphones or laptops, standalone microphones used in professional audio equipment, headsets with integrated microphones, and voice-activated smart home devices equipped with microphones for recognizing voice commands.

In the context of generating tuning commands 320 for calibrating an autonomous agent 100, audio capture devices 2232 may be used to interpret spoken commands or instructions provided by a human operator. The audio signal captured by the microphone may be processed using speech recognition software to translate speech into text, wherewith the text may be analyzed to identify relevant tuning commands 320 that align with predefined parameters of the autonomous agent 100.

For instance, if a verbal command such as “Make the robot move faster” were issued, the captured audio signal may be processed to recognize the command within the speech context. This recognition may result in alterations to parameters related to the speed of the autonomous agent 100 within the teachable behavior model 300. Such processing may allow for intuitive interactions with the system 2000, facilitating the adjustment of behavior of the autonomous agent 100 based on real-time verbal feedback.

In one embodiment, the user input device 2230 may include a text input device 2234 with which the tuning command 320 may be configured from a text signal carrying a text command captured therewith. The text input device 2234 may be understood as a hardware or software component that permits training agents 4000 to enter text into a system 2000. Examples of the text input device 2234 may include keyboards, whether physical, virtual, or touchscreen with on-screen keyboards, and any device with text entry capabilities, such as smartphones or tablets. Additionally, for a virtual environment or software application, reference may be made to text boxes or input fields where information may be typed using the text input device 2234.

In the context of generating tuning commands 320 for calibrating an autonomous agent 100, a text input device 2234 may be utilized to capture commands or instructions that may influence the teachable behavior model 300 of the autonomous agent 100. In one embodiment, directives such as “increase speed by 10%” or “reduce aggression level” may be inputted into a text interface by a training agent 4000. The system 2000 may interpret these directives to adjust corresponding teachable parameters 310, such as a velocity parameter or an aggression score, within the teachable behavior model 300 of the autonomous agent 100. Thereby, fine-tuning may be achieved based on textual input, allowing iterative refinement to reach desired performance outcomes.

A user input device 2230 may include a video capture device 2236, and a tuning command 320 may be configured from a video signal carrying a gesture capture. A video capture device 2236 may encompass any hardware or software capable of capturing visual information in the form of video signals. Examples of a video capture device 2236 may include cameras in smartphones, webcams on computers, specialized motion capture equipment used in animation and film production, or surveillance cameras. A video capture device 2236 typically converts optical data, such as light and motion, into digital signals that may be processed by a computing system for analysis. In the context of generating a tuning command 320, a video capture device 2236 may be utilized in applications involving an autonomous agent 100, especially virtual actors in a digital or mixed-reality environment. For instance, motion capture technology may track the movement of human actors to create realistic animations for virtual actors in films and video games. Through the capture and analysis of motion data, specific gestures or postures may be identified and associated with corresponding actions or expressions of virtual characters. When employing a video capture device 2236, the movements or expressions captured from a human model may be processed to generate a tuning command 320 for a teachable behavior model 300 of an autonomous agent 100. This tuning command 320 may instruct a virtual agent to replicate or transition into certain poses, expressions, or gestures, thereby calibrating 1200 the teachable behavior model 300 to incorporate more natural or context-appropriate reactions. For example, if a performance involves an emotional scene, the captured subtle facial movements and body language of a human actor may be translated into a tuning command 320 that adjusts key parameters in the teachable behavior model 300, ensuring that a virtual character exhibits similar emotional responses.

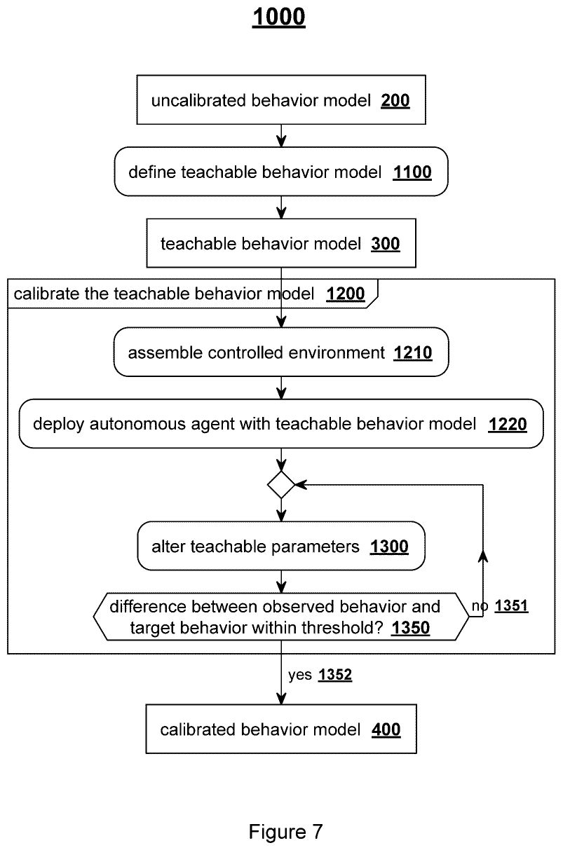

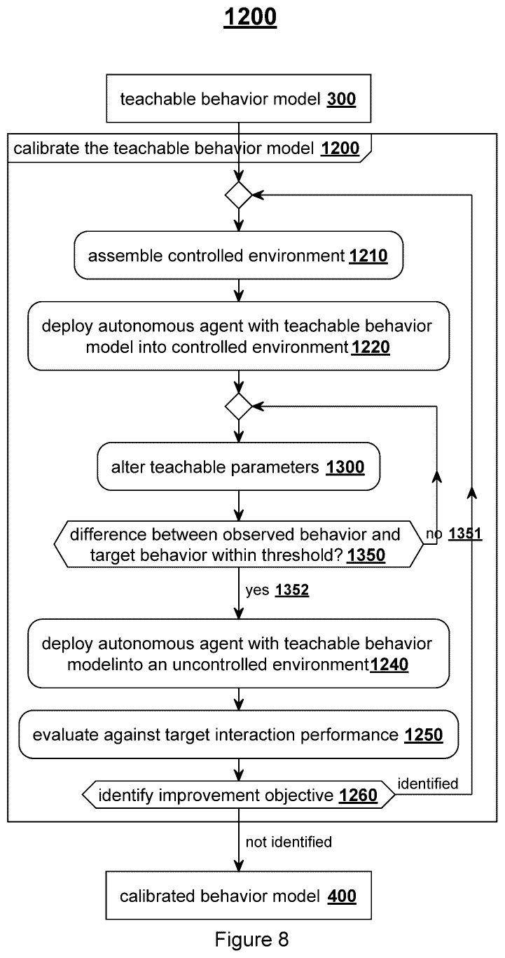

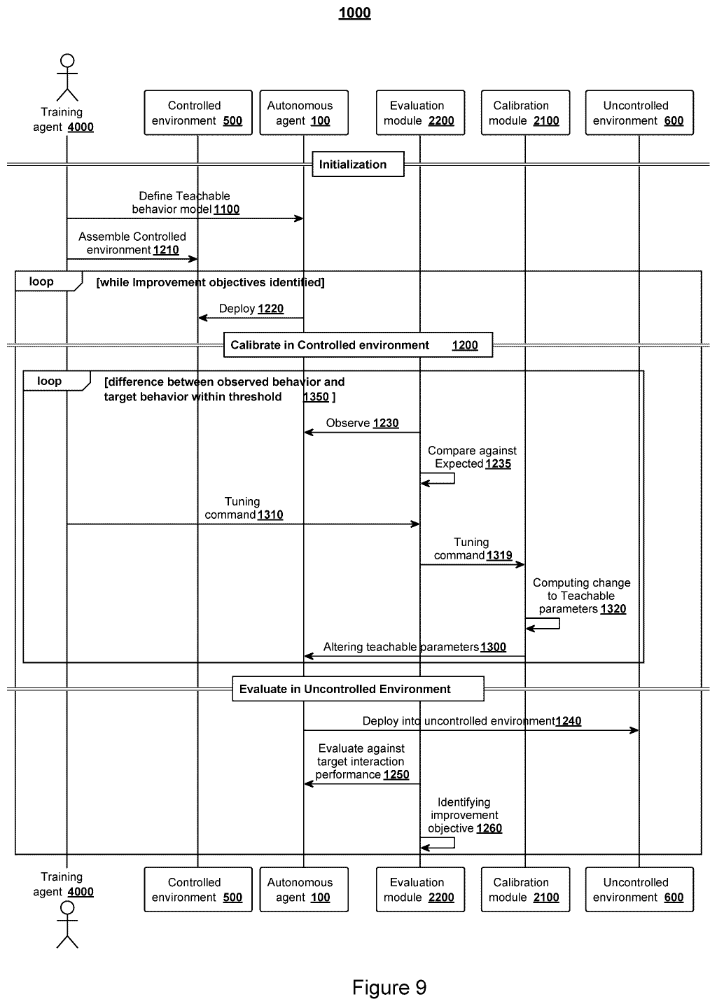

A second aspect of the teachings presented herein relates to a method 1000 for calibrating an autonomous agent 100. Reference is now made to the drawings in which FIG. 7 is a flow chart depicting an exemplary method 1000 for calibrating an autonomous agent 100, and FIG. 8 is a flow chart depicting an exemplary method for calibrating 1200 a teachable behavior model 300 of an autonomous agent 100 in a controlled environment 500, in accordance with the teachings of the present invention. Reference is also being made to the drawings in which FIG. 9 is a sequence diagram depicting an exemplary method 1000 for calibrating an autonomous agent 100, in accordance with the teachings of the present invention.

A set of instructions for calibrating an autonomous agent 100 may be stored on a non-transitory computer-readable medium. Upon execution by one or more processors of a device, these instructions may allow the device to execute the method 1000 or portions thereof. The capabilities of the calibration module 2100 may also be stored on a non-transitory computer-readable medium as a set of instructions. In addition, capabilities of the evaluation module 2200 may similarly be stored on a non-transitory computer-readable medium as a set of instructions for evaluating an autonomous agent 100.

A teachable behavior model 300 may be defined 1100 from an uncalibrated behavior model 200 adjusted by a plurality of model parameters 210. The process of defining 1100 the teachable behavior model 300 for the autonomous agent 100 hypothesizes utilization of the uncalibrated behavior model 200. The uncalibrated behavior model 200 used may be described as a decision system 380, which may encompass examples such as a Finite State Machine, a Markov Decision Process, a Decision Tree, a Behavior Tree, a Rule-Based System, a Utility System, a Graph-Based AI, and Hierarchical Task Networks. Different decision systems within the context of creating teachable behavior models may be applied without limiting the potential applicability of the invention.

The plurality of model parameters 210 may include an active state 350 from a plurality of defined states 360 and one or more teachable parameter 310 for transitioning the active state 350 within the plurality of defined states 360.

The teachable behavior model 300 may be calibrated 1200 into a calibrated behavior model 400 by assembling 1210 a controlled environment 500 with one or more teaching fixture 510. The teachable parameters 310 may regulate behavioral aspects such as decision-making algorithms, movement patterns, dialogue choices, etc. For instance, if the behavior of the autonomous agent 100 is observed to exhibit excessive aggression, the teachable parameters 310 associated with aggression may be modified to adjust the behavior of the autonomous agent 100 to be more balanced and pleasant to interact with. The teachable parameters 310 of the teachable behavior model 300 may comprise elements such as a preference score 312 or a rule-based system 314 for transitioning to an active state 350 within the teachable behavior model 300.

The autonomous agent 100 may be deployed 1220 in a controlled environment 500, with the controlled environment 500 defined as either a specific physical location or a virtual scene. In instances where the controlled environment 500 may be defined as a specific physical location, physical components such as teaching fixtures 510, including walls, objects, and other physical boundaries, may be included that interact with the autonomous agent 100 in a real-world setting. Thereby scenarios may be created where teachable parameters 310 of the teachable behavior model 300 may be assessed and adjusted.

Alternatively, when the controlled environment 500 is represented as a virtual scene, real-world conditions or any imaginable settings within a digital framework may be simulated. The virtual scene may be constructed out of digital renderings, thereby permitting extensive control over environmental variables and conditions without the limitations posed by physical constraints. Virtual scenes may include objects, characters, or challenges designed to evoke specific responses from the autonomous agent 100, focusing on refining the teachable behavior model 300 within safely managed parameters.

This virtual setup supports fine-tuning various aspects of the decision-making processes of the autonomous agent 100 in ways more adaptable and repeatable compared to physical realms.

The one or more teachable parameter 310 may be altered 1300 to reduce a difference between an observed behavior and a target behavior 410 until 1350 the difference is within a target threshold. The alteration may involve modifying parameters such as a preference score 312 or updating rules within a rule-based system 314 to align the performance of the autonomous agent 100 more closely with the target behavior 410 specified for the deployment environment. Through this adjustment process, the teachable behavior model 300 may be calibrated 1200 to ensure that the actions of the autonomous agent 100 are consistent with desired goals, thereby achieving a calibrated behavior model 400.

Iterative steps may be undertaken to calibrate the teachable behavior model 300 into a calibrated behavior model 400. Upon deployment 1220 of the autonomous agent 100 in the controlled environment 500, observation of the autonomous agent 100 may occur, and alterations 1300 to the teachable parameters 310 may be implemented based on the observed behavior. This process may be repeated until the difference between the observed behavior and the target behavior 410 is within a target threshold, thereby achieving alignment with the target behavior 410.

The calibrating of a teachable behavior model 300 may consist of applying alterations 1300 to the teachable parameters 310. When the observed behavior of the autonomous agent 100 is outside of a tolerance threshold, the calibration process may be repeated. Once the observed behavior is within the tolerance threshold, the calibration process may terminate, and the teachable behavior model 300 may be calibrated into a calibrated behavior model 400. It may be understood that during the deployment of an autonomous agent 100 behaving according to the calibrated behavior model 400 in an uncontrolled environment 600, teachable parameters 310 may not be required. However, teaching parameters 310 of the teachable behavior model 300 may be beneficially retained in the calibrated behavior model 400 if the calibrated behavior model 400 is expected to be further adjusted.

In different embodiments, the tolerance threshold may vary according to specific objectives associated with a training agent 4000. For example, in the context of animating a large crowd in a movie production, it may be conceivable for some autonomous agents 100 rendered in a scene to exhibit somewhat erratic behavior, provided the overall appearance of crowd behavior is satisfactory. Conversely, in a video game setting, autonomous agents 100 designed for direct interaction with players may necessitate a lower tolerance threshold to ensure engagement is maintained. In some embodiments, the tolerance threshold may encompass a subset of actions for which the autonomous agent 100 is expected to perform with precision, permitting variability in non-critical behaviors. For instance, within a video game, it may be imperative for a Non-Player Character (NPC) to navigate obstacles while allowing occasional failures in successfully parrying attacks. Alternatively, thresholds may comprise quantitative figures, such as considering a teachable behavior model 300 acceptable if an adversarial encounter with an experienced player lasts between 60 and 300 seconds. The thresholds employed to evaluate whether the teachable behavior model 300 is satisfactorily calibrated may vary according to the specific context and intended purpose of the calibration process.

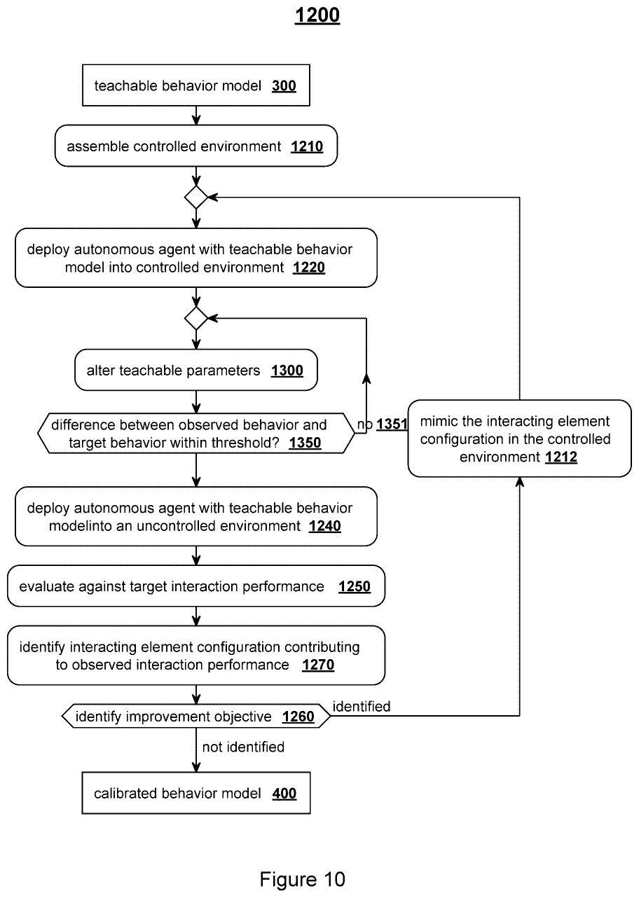

Reference is now made to the drawings in which FIG. 10 is a flow chart depicting an exemplary method for calibrating a teachable behavior model 300 of an autonomous agent 100 by mimicking 1212 interacting elements 610 from an uncontrolled environment 600, in accordance with the teachings of the present invention. The autonomous agent 100, having the teachable behavior model 300 assigned thereto, may be deployed 1240 into an uncontrolled environment 600 comprising interacting elements 610. The uncontrolled environment 600 may, in some embodiments, represent a different location within a real or virtual scene in comparison to the controlled environment 500. Alternatively, in other embodiments, the uncontrolled environment 600 may represent a different virtual scene. The uncontrolled environment 600 may offer interacting elements 610 identical, or meant to be representative of real-life scenarios for which the teachable behavior model 300 was designed.

Iterations between the uncontrolled environment 600 and the controlled environment 500 may be performed such that an improvement objective 420 is ultimately achieved, where the teachable behavior model 300 operates in accordance with expectations within the uncontrolled environment 600.

The observed interaction performance of an autonomous agent 100 with interacting elements 610 may be evaluated 1250 against a target interaction performance. An improvement objective 420 may be identified 1260 based on the observed interaction performance in contrast to the target interaction performance. The target behavior 410 may incorporate the identified improvement objective 420.

In the context of the method 1000, the calibrated behavior model 400 may be attached to the autonomous agent 100 before deployment in the uncontrolled environment 600. A behavioral assessment may be obtained to evaluate an improvement objective 420. This behavioral assessment may be obtained through analysis of feedback provided by a human observer or by other means, such as executing scripted tests or assessing the behavior of the autonomous agent 100 using another trained AI model (not shown).

When a tuning command 320 is issued by a training agent 4000 for the behavioral assessment, the training agent 4000 may act as an expert engaged in reinforcement teaching. Upon observing an inadequate behavior from the calibrated behavior model 400, as assessed by the training agent 4000, an autonomous agent 100 may be deployed 1220 with the calibrated behavior model 400 into the controlled environment 500. From the behavioral assessment and with the deployment 1220 of the autonomous agent 100 in the controlled environment 500, steps equivalent to steps 1300 to 1350 of method 1000 may be conducted to refine the calibrated behavior model 400 accordingly.

Additional alterations 1300 may be applied to the teachable parameter 310 of the calibrated behavior model 400 to improve the behavior of the calibrated autonomous agent 100. Correcting undesired behavior may result in reducing the difference between the target behavior 410 and the observed behavior. Once the observed behavior of the calibrated autonomous agent 100 is within the corresponding target threshold, a refined calibrated model (not shown) may be obtained.

The calibrated behavior model 400 may be deployed 1240 to the uncontrolled environment 600 and subsequently returned to the controlled environment 500 repeatedly, wherewith additional alterations 1300 may be applied until the difference between the observed behavior and the target behavior 410 is confined within a target threshold. When the improvement objective 420 remains unmet, the process may be reiterated; otherwise, the calibrated behavior model 400 may be attained as the result of the iterative process.

In certain embodiments, iterations may be performed in an environment distinct from the controlled environment 500. The controlled environment 500 may function as an initial aid in the calibration of the autonomous agent 100, while enhancing behavior aspects detected in the uncontrolled environment 600 may necessitate defining 1100 particular conditions within the controlled environment 500 to refine the teachable behavior model 300. The controlled environment 500 may be configured to mimic 1212 the uncontrolled environment 600 with specific conditions designed to more readily elicit an observed problematic behavior from the autonomous agent 100, such as specific characteristics or states of the teaching fixture 510 and/or user-interface widgets 2252.

An interacting element configuration contributing to the observed interaction performance may be identified 1270, and the identified configuration may be mimicked 1212 using the one or more teaching fixture 510. The deploying 1240 of the autonomous agent 100 to the uncontrolled environment 600 may occur following the completion of method 1000 and the attainment of the calibrated behavior model 400. The controlled environment 500 may further incorporate teaching fixtures 510 configured to mimic interacting elements extant in the uncontrolled environment 600 when behavioral assessment occurs in the uncontrolled environment 600. For example, where the calibrated behavior model 400 is intended to conceal the autonomous agent 100 behind objects but fails to accomplish this with a specific configuration of trees, the controlled environment 500 may be specifically constructed to evaluate this scenario. In situations where the uncontrolled environment 600 is virtual, the generation of the controlled environment 500 may be feasible by recording interactions of the autonomous agent 100 in the uncontrolled environment 600, during a simulation, where behavior in need of adjustment is observable.

In embodiments, the uncalibrated behavior model 200 comprises a decision system 380. Optionally, the decision system 380 may include at least one of a Finite State Machine, a Markov Decision Process, a Decision Tree, a Behavior Tree, a Rule-Based System, a Utility System, a Graph-Based AI, and a Hierarchical Task Networks.

In embodiments, the one or more teachable parameter 310 may include at least one of a preference score 312 and a rule-based system 314 for transitioning to the active state 350 of the teachable behavior model 300 within the defined states 360.

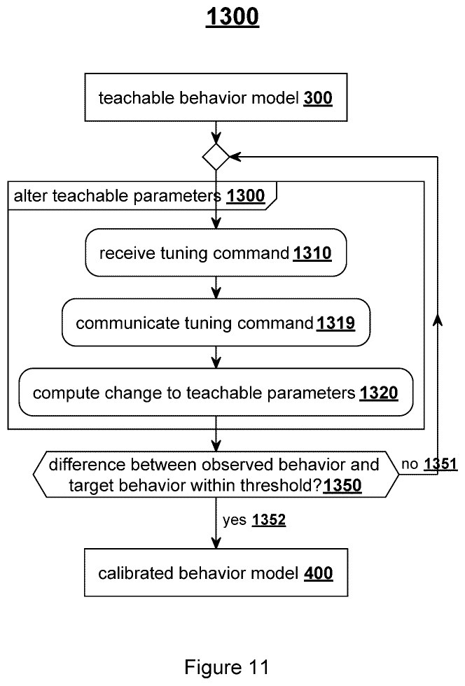

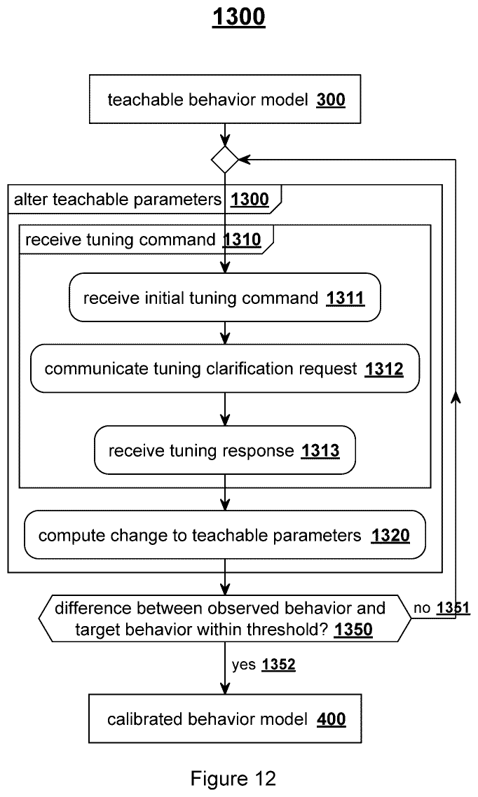

Reference is now made to the drawings in which FIG. 11 is a flow chart depicting an exemplary method for altering 1300 teachable parameters 310 of a teachable behavior model 300 of an autonomous agent 100, and FIG. 12 is a flow chart depicting an exemplary method for altering 1300 teachable parameters 310 of a teachable behavior model 300 of an autonomous agent 100 with feedback, in accordance with the teachings of the present invention.

In embodiments, a tuning command 320 with one or more contextual condition 330 may be received 1310 by the calibration communication module 2170 or the user-interface module 2250, from a training agent 4000. A change to the one or more teachable parameter 310 may be computed 1320 from the tuning command 320.

The alterations may be obtained by receiving from a training agent 4000 issuing a tuning command 320, the command which captures at least one contextual condition. Contextual conditions are parameters of the interacting elements of the environment, or attributes of the autonomous agent 100 which provide context for decision making. A behavior may be broadly described as a “what” and “when,” whereby an action is taken (“what”) upon specific circumstances (“when”). For example, taking cover (“what”) when it rains (“when”). Capturing contextual conditions may contribute to creating rich and sophisticated behaviors. For example, a training agent 4000 may interact with the autonomous agent 100 commanding that the autonomous agent should take cover when it rains. The commands provided by the training agent 4000 may result in the alteration of one or more teachable parameters 310.

When received 1310 by the user-interface module 2250, the tuning command 320 may be communicated 1319 to a calibrating device 2100 using the evaluation communication module 2270.

Observation 1230 of the autonomous agent 100 by the evaluation module 2200 may gather information about the status 110 of the autonomous agent 100. The gathered information may be rendered 1232 to the user-interface module 2250, allowing for a comparison 1235 to be made by a training agent 4000 between the behavior of the autonomous agent 100 and a target behavior 410.

In embodiments, an initial tuning command with at least one initial contextual condition may be received 1311 by the calibration communication module 2170 or the user-interface module 2250, from the training agent 4000. A tuning clarification request, related to the initial tuning command, may be communicated 1312 to the training agent 4000. A tuning response with at least one additional contextual condition may be received 1313, from the training agent 4000. The tuning command 320 may include the initial tuning command and the tuning response.

The training agent 4000 may further engage in an interaction for a calibration clarification, capturing more contextual conditions with at least one attribute of the autonomous agent 100. For example, after performing an adjustment to the teachable behavior model in the form of a tuning command that prompts the autonomous agent 100 to take cover when it rains, the autonomous agent 100 may interact with the training agent 4000 to request additional information about the command. For instance, the autonomous agent 100 might inquire why it should take cover when it rains, to which the training agent 4000 might respond that the autonomous agent 100 does not enjoy being wet. The response from the training agent 4000 provides additional context that may enable the autonomous agent 100 to infer additional teachable parameters, and the alterations may be computed from a combination of both the tuning command and the calibration clarification. For example, the generated parameters may adjust the teachable parameters such that the teachable behavior model may decide to avoid swimming actions or flee under the threat of water.

The behavior model may also include additional behavioral aspects associated with the teachable parameters. Metadata may be associated with the teachable parameter, describing limits and observable effects of the teachable parameter. The teachable parameter metadata may be used to convert a tuning command into alterations of teachable parameters. For example, a tuning command that requests the autonomous agent 100 to move faster needs to find teachable parameters associated with the velocity of the autonomous agent 100. Additionally, the velocity parameters may only be altered within limits.

In some embodiments, tuning commands 320 may be suggested to a training agent 4000 through the provision of a list of likely tuning commands 320 given the context thereof. Specialized tools may be available in a controlled environment 500 to guide the tuning commands 320. These specialized tools may include mechanisms for a training agent 4000 to point to a location where an autonomous agent 100 should have positioned itself or to draw attention to certain objects within the environment. The specialized tools may be implemented through a user-interface widget 2252 for issuing tuning commands 320, thereby facilitating precise calibration of a teachable behavior model 300 of an autonomous agent 100. The specialized tools may be integrated into the user-interface module 2250 for allowing intuitive and efficient guidance of the calibration process by entities such as a training agent 4000. The user-interface widget 2252 may include visual elements such as buttons, sliders, or graphical controls to represent different parameters of a teachable behavior model 300, thereby enhancing interactivity thereof. Specialized tools might encompass drag-and-drop interfaces, annotation capabilities, or graphical overlays that may highlight specific parameters of interest in a given scenario. For example, an interface might display an environment with an autonomous agent 100 interacting with various objects, thereby allowing a training agent 4000 to employ a drag-and-drop tool to overlay areas of a map where behavior needs adjustment, thereby triggering a tuning command 320 associated with the highlighted areas. Furthermore, the user-interface widget 2252 may offer interactive visual simulations, such as timelines or playbacks of previous scenarios in the controlled environment 500, thereby aiding in comprehensive evaluation and calibration efforts.

Specialized tools integrated within the interface may allow the training agent 4000 to rewind and replay particular moments, observing the behavior of the autonomous agent 100 in relation to specific contextual conditions 330. Where a behavior at a certain point requires adjustment, interaction with the timeline to mark or annotate the moment may result in formulating a tuning command 320 to refine teachable parameters 310. Specialized tools may also encompass AI-assisted suggestions that augment the decision-making process of the training agent 4000. Based on patterns and previous calibrations, the system 2000 may present a list of suggested tuning commands 320 as selectable options within the user-interface widget 2252, thereby enhancing the calibration workflow by providing smart recommendations.

Specialized tools may be enhanced by employing augmented reality with physical autonomous agents 100. Augmented reality tools may visualize pathways, obstacles, and a range of potential interactions within the real world, overlaying this information into the physical space where the autonomous agent 100 is deployed. Augmented reality implementations may permit a training agent 4000 to interact directly with the physical environment, issuing precision tuning commands 320 as users navigate through and adjust real-world stimuli.

In embodiments, each teachable parameter 310 from the one or more teachable parameters 310 may be associated with descriptive metadata 340, and when computing 1320 the change to the teachable parameters 310, the tuning command 320 may be interpreted using descriptive metadata 340. The descriptive metadata 340 may allow the teachable parameters 310 to be anticipated, thereby enabling informed calibrating 1200 decisions. Additionally, descriptive metadata 340 may specify how teachable parameters 310 may be adjusted, including whether teachable parameter 310 values are continuous, discrete, bounded, etc. The descriptive metadata 340 may include a limit range 341 that indicates the permissible bounds for modifying a teachable parameter 310. For example, a velocity parameter may have an allowable range of adjustment, ensuring the teachable parameter 310 is not set to an excessively high or low value, which may be unrealistic for the operation of the autonomous agent 100.

The descriptive metadata 340 may also provide an observable effect description 342. An observable effect description 342 may be included in the descriptive metadata 340 to delineate the anticipated behavioral impact resulting from adjustments to a teachable parameter 310. When a Non-Player Character (NPC) within a game possesses a teachable parameter 310 associated with an aggression level, augmenting this teachable parameter 310 may result in more frequent engagements in combat scenarios. In the context of a virtual autonomous agent 100 in digital media production, if a teachable parameter 310 governs sensitivity to environmental lighting conditions, the descriptive metadata 340 may indicate that this teachable parameter 310 allows continuous adjustments spanning a range from total darkness to full illumination. The observable effect description 342 may delineate the extent to which variations in light may affect visibility or movement of the virtual autonomous agent 100. In a consumer device such as a smart thermostat, a teachable parameter 310 may govern temperature setpoints, and the associated descriptive metadata 340 may specify the teachable parameter 310 as discrete, permitting only pre-defined temperature increments such as 0.5° C. steps. The observable effects may be listed as changes in energy consumption patterns or comfort levels. Through the use of descriptive metadata 340, tuning commands 320 may be accurately mapped to the relevant teachable parameters 310, permitting systematic refinement to achieve the target behavior 410. This architecture of descriptive metadata 340 may transform subjective user intent into fine-grained technical specifications that guide and constrain the calibration process, ensuring that adjustments are contextually appropriate.

In embodiments, when receiving 1310 the tuning command 320, a selection from a list of suggested commands may be received 1310. The user-interface widget 2252 may include the list of suggested commands, and the tuning command 320 may be configured therefrom using the user input device 2230. The user-interface widget 2252 may present a dynamically updating list of suggested commands tailored to the current status or context affecting the autonomous agent 100. These user-interface widgets 2252 may incorporate interactive elements such as buttons, lists, sliders, or icons designed to guide users in issuing commands or adjusting parameters within the system 2000. If the autonomous agent 100 encounters specific situations such as being blocked or running low on battery, commands relevant to these circumstances may be prominently exhibited within the user-interface widget 2252. This configuration of commands may ensure that operators are provided with pertinent options, thereby facilitating decision-making and operational execution efficiency.

In a scenario where the autonomous agent 100 is blocked by an obstacle, widgets may offer suggestions such as:
“Navigate around obstacle”
“Attempt alternative route”
“Request human intervention”
“Activate obstacle avoidance mode”

Similarly, in the situation where the autonomous agent 100 is running low on battery, suggested commands might include:
“Return to charging dock”
“Switch to energy-saving mode”
“Suspend non-critical tasks”
“Alert user about battery status”

Once a suggested command is selected by the training agent 4000, the suggested command may be converted into a tuning command 320 and may be processed to modify the teachable parameters 310 of the teachable behavior model 300.

The tuning command 320 may be received 1310 from an event originating from a user-interface widget 2252. For example, adjusting a slider within a graphical interface to modify the speed of the autonomous agent 100 may generate a tuning command 320 from this slider adjustment. The tuning command 320 may be received 1310 from an audio signal carrying speech. For instance, a spoken phrase such as “increase the cleaning efficiency of the robot” captured via a microphone may be processed into a tuning command 320 to adjust relevant parameters. The tuning command 320 may be received 1310 from a text signal carrying a text command. For example, a typed instruction like “reduce aggressiveness” entered into a text interface may be translated into a command to decrease the parameter controlling the aggression level of a virtual character. The tuning command 320 may be received 1310 from a video signal carrying a gesture. For instance, a gesture such as pointing to a location on a map within the controlled environment 500 may signify a command for the autonomous agent 100 to move to the indicated location, thereby configuring a tuning command 320 based on the captured movement.

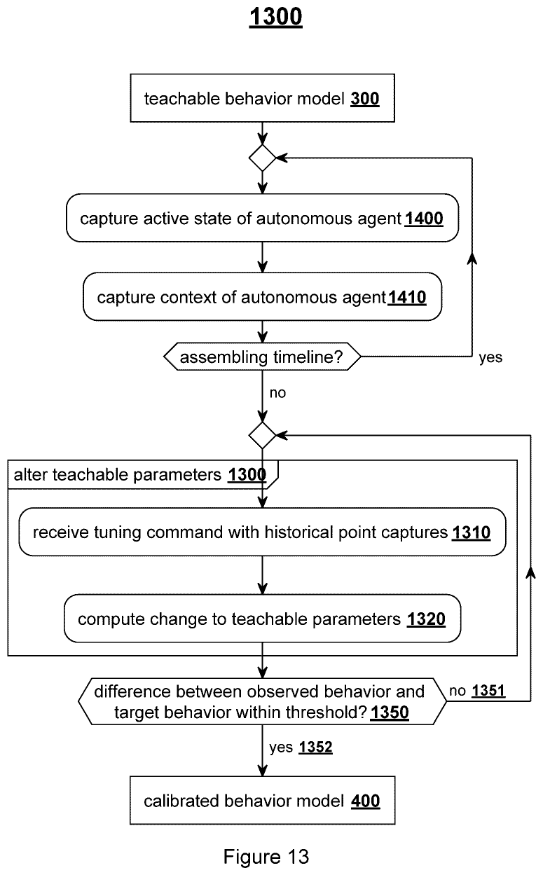

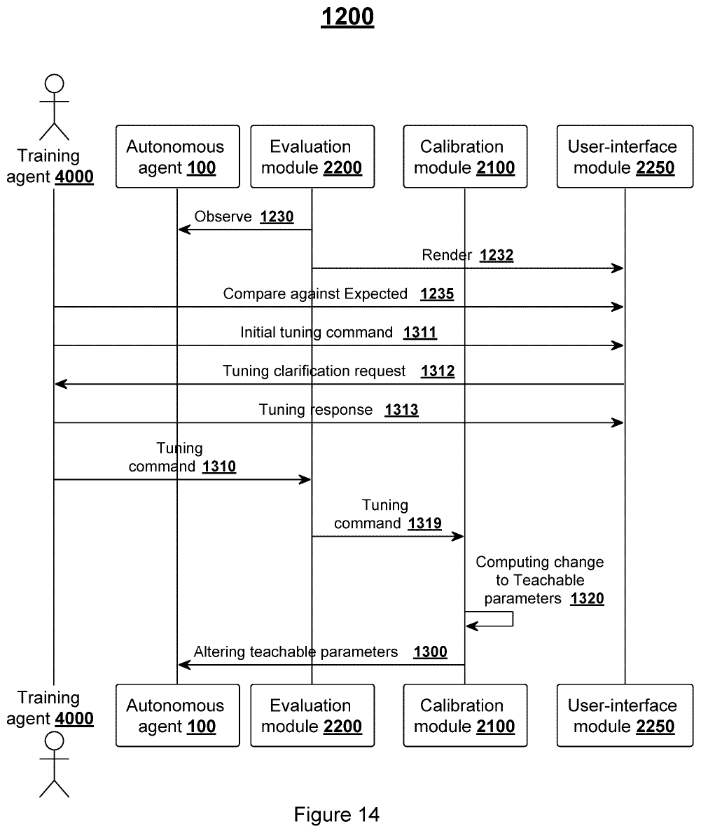

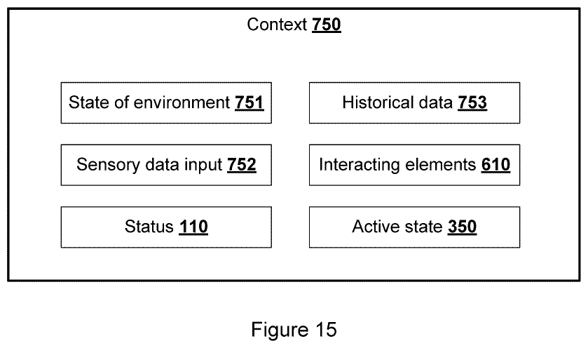

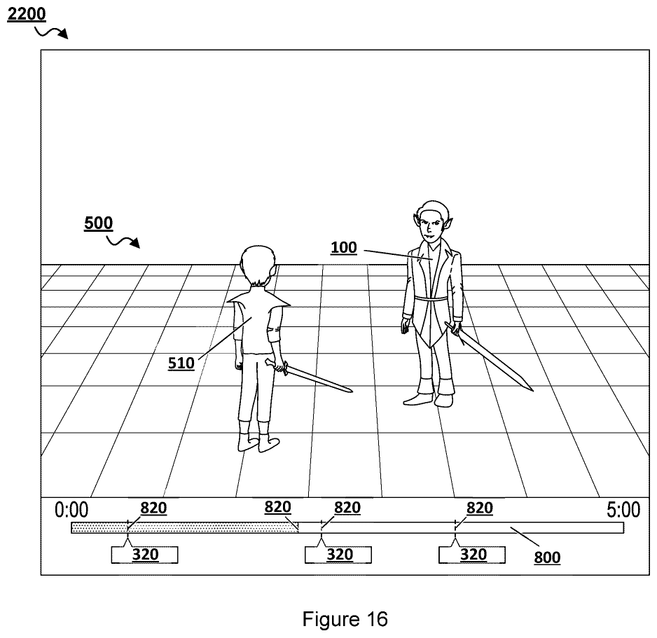

Reference is now made to the drawings in which FIG. 13 is a flow chart depicting an exemplary method for altering teachable parameters 310 of a teachable behavior model 300 of an autonomous agent 100 with historical captures, FIG. 14 is a sequence diagram depicting an exemplary method for calibrating 1200 a teachable behavior model 300 of an autonomous agent 100 with historical captures, FIG. 15 is a block diagram depicting an exemplary context 750 captured when altering teachable parameters 310 of a teachable behavior model 300 of an autonomous agent 100 with historical captures, and FIG. 16 is a drawing depicting an exemplary system for calibrating 1200 a teachable behavior model 300 of a virtual autonomous agent 100 using a timeline 800 for historical captures, in accordance with the teachings of the present invention.

In embodiments, while deployment 1220 of the autonomous agent 100 occurs in the controlled environment 500, both the active state 350 of the autonomous agent 100 and the capturing 1410 of a context 750 of the autonomous agent 100 may be captured 1400 at a plurality of capture points 820 within a timeline 800. The recorded timeline 800 of the states of the autonomous agent 100 and the state of a corresponding surrounding environment may be utilized to facilitate the calibration process of the teachable behavior model 300 by capturing additional context therefrom. To alter a behavior occurring at a specific point in time, navigation back to a time of interest may be possible within the timeline 800, allowing the restoration of the autonomous agent 100 and the corresponding surroundings to their recorded states. By selecting a particular time within the timeline 800, a training agent 4000 may convey additional contextual information, wherewith contextual conditions 330 indicated may be integrated with a tuning command 320. The active state 350 of the autonomous agent 100 and the context 750 from at least one historical point within the plurality of capture points 820 may be included in at least one contextual condition from a set of contextual conditions 330. Within a video game scenario, the active state 350 of the autonomous agent 100 may encompass a gameplay action by a non-playing character. For instance, at a specific point within the timeline 800, the autonomous agent 100 may be an NPC that has just been impacted by another character. In such a situation, it may be inferred that the tuning command 320 supplied by the training agent 4000 pertains to conditions where the autonomous agent 100 incurs damage in combat.

The context 750 of the autonomous agent 100 may encompass pertinent information and circumstances surrounding the autonomous agent 100 within a given environment, incorporating parameters relevant to decision-making and behavior adaptation thereof. The context 750 may include the state of the environment 751, inputs derived from sensory data 752, the status 110 of the autonomous agent 100, any interacting elements 610 that may influence the active state 350 thereof, and historical data 753, such as a recent sequence of events. Capturing the context 750 may facilitate informed calibrating 1200 processes by integrating elements that contribute to the operational conditions and decision-making framework of the autonomous agent 100. A snapshot of both internal states and external conditions experienced by the autonomous agent 100 at a given time may be provided, thereby assisting in fine-tuning the teachable parameters 310 to achieve desired behavioral outcomes in various scenarios.

During an initialization phase, a teachable behavior model 300 may be defined 1100 and assigned to the autonomous agent 100. A controlled environment 500 may be defined for deployment 1220 of an instance of the autonomous agent 100 thereinto.

A controlled environment 500, during a calibrating phase 1200, may be used to alter 1300 underlying teachable parameters 310 of the teachable behavior model 300 in a controlled manner. A training agent 4000 may observe 1230 the behavior of an autonomous agent 100 interacting with teaching fixtures 510 of the controlled environment 500. The behavior may be compared 1235 against a target behavior 410, and the training agent 4000 may choose to calibrate the observed behavior by generating a tuning command 320. The tuning command 320 may be received by a calibration module 2100. Upon receiving 1310 the tuning command 320, the calibration module 2100 may compute alterations 1300 which are then applied to the teachable parameters 310 of the autonomous agent 100. The calibrating phase 1200 may be repeated 1351 until the observed behavior is within a target threshold 1350 when compared to the target behavior 410. When the observed behavior is within a target threshold 1352, the teachable behavior model 300 may be considered to be the calibrated behavior model 400.

The teachable behavior model 300 may be associated with the calibrated autonomous agent 100 when deployed 1240 in the uncontrolled environment 600. A training agent 4000 may observe the behavior of the calibrated autonomous agent 100 interacting with the interacting elements 610 of the uncontrolled environment 600, generating a behavioral assessment thereof and identifying 1260 improvement objectives 420. An instance of the calibrated autonomous agent 100 may be deployed 1220 again into the controlled environment 500 where a new calibration session may be executed. The training agent 4000 observes the behavior of the calibrated autonomous agent 100 and compares the observed behavior against an expected behavior. A tuning command 320 may be generated and received 1310 by the calibration module 2100, which computes 1320 additional changes applied to the teachable parameters 310 of the calibrated autonomous agent 100. The calibration phase 1200 may be repeated until the behavior from the behavioral assessment has been successfully calibrated. Once the adjusted model is obtained, the recalibrated autonomous agent 100 is deployed 1240 into the uncontrolled environment 600 for further behavioral assessment.

The calibration module 2100 may be deployed as a remote service, wherewith communication may occur via a network protocol such as a RESTful API over an HTTP connection. In this embodiment, tuning commands 320 received by the calibration module 2100 may encompass adequate contextual information to enable a stateless service, whereby alterations 1300 may be computed solely based on the tuning command 320 and a pre-trained model. Alternatively, the calibration module 2100 may preserve a state for context inference.

The invention described may allow for variations of the described embodiments, which may still be encompassed within the scope of the appended claims. The terminology employed herein pertains to the purpose of describing certain embodiments and may not be intended as limiting. Instead, the scope of the invention may be delineated by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the expression “at least one of” followed by a set of elements suggests that any combination of the elements from the set is being considered, including a single element from the set, and all elements from the set.

For clarity, “at least one of” followed by a set does not strictly refer to having at least the whole set once, and possibly multiple times.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As will be understood by a skilled person, other variations and combinations may be made to the various embodiments of the invention as described herein above. The scope of the claims should not be limited by the preferred embodiments set forth; but should be given the broadest interpretation consistent with the description as a whole.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

A system may generally be conceived as an arrangement of multiple components that work together to achieve a particular function or result. These components each may have distinct roles and contribute to the overall operation of the system. It is convenient to describe these components as units, modules, parts, or elements. Components may be physical or logical in nature. In practice, systems may be implemented in various forms. While systems are typically comprised of multiple distinct components, in some embodiments, all or some components may coexist within a single device. This integration does not alter the fundamental understanding of the operation but rather represents an embodiment where functionality is consolidated. Such a configuration may be advantageous for specific applications where space, efficiency, or other considerations are paramount. Regardless of configuration, systems are understood to operate through physical interactions, which may, in some embodiments, be achieved through electronic components such as RAM, buses and processors.

What is claimed is:

1. A system for calibrating an autonomous agent, the system comprising:
the autonomous agent having a teachable behavior model assigned thereto, the teachable behavior model comprising
an active state from a plurality of defined states; and
one or more teachable parameter for transitioning the active state within the plurality of defined states
a controlled environment comprising one or more teaching fixture and configured to deploy the autonomous agent thereinto; and
a calibration module comprising:
one or more calibration processor configured to:
alter the one or more teachable parameter to reduce a difference between an observed behavior and a target behavior, thereby calibrating the teachable behavior model of the autonomous agent into a calibrated behavior model.

2. The system of claim 1, further comprising:
an uncontrolled environment comprising interacting elements and configured to deploy the autonomous agent thereinto;
an evaluation module comprising:
one or more evaluation processor configured to:
identify an improvement objective when the autonomous agent is deployed in the uncontrolled environment;
wherein the calibration module further comprises:
a calibration communication module configured to:
receive the improvement objective; and
wherein the target behavior comprises the improvement objective, the one or more calibration processor being further configured to alter the one or more teachable parameter to reduce the difference between the observed behavior and the target behavior considering the improvement objective.

3. The system of claim 2 wherein the one or more evaluation processor is further configured to:
identify an interacting element configuration from the interacting elements contributing to an observed interaction performance when the autonomous agent is deployed in the uncontrolled environment; and
wherein the one or more teaching fixture is configured to:
mimic the interacting element configuration when the autonomous agent is deployed in the controlled environment.

4. The system of claim 1, wherein the autonomous agent is an autonomous robot, and the controlled environment is a development environment.

5. The system of claim 1, wherein the autonomous agent is a virtual actor in a digital media production, and the controlled environment is a virtual scene.

6. The system of claim 1, wherein the autonomous agent is a non-playing character in a digital interactive production, and the controlled environment is a development scene.

7. The system of claim 1, wherein the autonomous agent is a decision agent controlling one or more object of the controlled environment, and the controlled environment is a development scene.

8. The system of claim 1, wherein the one or more teachable parameter comprises at least one of a preference score and a rule-based system for transitioning to the active state of the teachable behavior model within the defined states.

9. The system of claim 2, wherein:
the calibration communication module is further configured to:
receive, from a training agent, a tuning command comprising one or more contextual condition; and
the one or more calibration processor is further configured to:
compute a change to the one or more teachable parameter from the tuning command.

10. The system of claim 9, wherein each teachable parameter from the one or more teachable parameter is associated with a descriptive metadata, and wherein:
the one or more calibration processor is further configured to:
compute the change to the one or more teachable parameter using the descriptive metadata.

11. A method for calibrating an autonomous agent, the method comprising:
defining, from an uncalibrated behavior model adjusted by a plurality of model parameters, a teachable behavior model, the plurality of model parameters comprising:
an active state from a plurality of defined states; and
one or more teachable parameter for transitioning the active state within the plurality of defined states;
calibrating the teachable behavior model into a calibrated behavior model by:
assembling a controlled environment comprising one or more teaching fixture;
deploying, in the controlled environment, the autonomous agent having the teachable behavior model assigned thereto; and
until a difference between an observed behavior and a target behavior is within a target threshold:
altering the one or more teachable parameter to reduce the difference therebetween.

12. The method of claim 11, wherein calibrating the teachable behavior model further comprises:
deploying, into an uncontrolled environment comprising interacting elements, the autonomous agent having the teachable behavior model assigned thereto;
evaluating, against a target interaction performance, an observed interaction performance of the autonomous agent with the interacting elements;
identifying, from the observed interaction performance, an improvement objective; and
wherein the target behavior comprises the improvement objective.

13. The method of claim 12, wherein calibrating the teachable behavior model further comprises:
identifying an interacting element configuration contributing to the observed interaction performance; and
wherein assembling the controlled environment comprises:
mimicking the interacting element configuration using the one or more teaching fixture.

14. The method of claim 11, wherein the autonomous agent is an autonomous robot, and the controlled environment is a development environment.

15. The method of claim 11, wherein the autonomous agent is a virtual actor in a digital media production, and the controlled environment is a virtual scene.

16. The method of claim 11, wherein the autonomous agent is a non-playing character in a digital interactive production, and the controlled environment is a development scene.

17. The method of claim 11, wherein the autonomous agent is a decision agent controlling one or more object of the controlled environment, and the controlled environment is a development scene.

18. The method of claim 11, wherein the one or more teachable parameter comprises at least one of a preference score and a rule-based system for transitioning to the active state of the teachable behavior model within the defined states.

19. The method of claim 11, wherein altering the one or more teachable parameter comprises:
receiving, from a training agent, a tuning command comprising one or more contextual condition; and
computing a change to the one or more teachable parameter from the tuning command.

20. The method of claim 19, wherein each teachable parameter from the one or more teachable parameter is associated with a descriptive metadata, and wherein computing the change to the one or more teachable parameter is performed using the descriptive metadata.
